(19) United States
(12) Patent Application Publication
(10) Pub. No.: US 2025/0010550 A1
(43) Pub. Date: Jan. 9, 2025

(54) Three-Dimensional Printing Methods and Systems Thereof

(71) Applicant: SOUTHWEST GREENE INTERNATIONAL, INC. (dba Greene Group Industries, LLC), Oceanside, CA (US)

(72) Inventors: Jonathan Pomeroy, Newark, CA (US); David B. Lavo, Newark, CA (US); Pierre Pascal Anatole Lin, Newark, CA (US); Brian James Adzima, Newark, CA (US); Arian Aziz Aghababaie, Newark, CA (US)

(73) Assignee: SOUTHWEST GREENE INTERNATIONAL, INC. (dba Greene Group Industries, LLC), Oceanside, CA (US)

(21) Appl. No.: 18/712,606

(22) PCT Filed: Nov. 23, 2022
(86) PCT No.: PCT/US2022/080418

§ 371 Date: May 22, 2024

Related U.S. Application Data
(60) Provisional application No. 63/282,412, filed on Nov. 23, 2021.

(51) Int. Cl. B29C 64/386; B33Y 50/00

(52) U.S. Cl. CPC B29C 64/386; B33Y 50/00

(57) ABSTRACT

The present disclosure provides methods and systems for processing a three-dimensional (3D) object for printing by a 3D printer. The methods disclosed herein can allow printing of the 3D object at sub-pixel precision. The methods disclosed herein can comprise modifying a containment level of one or more sub-pixels or adjusting a light intensity level of a pixel comprising one or more sub-pixels.

### CROSS-REFERENCE TO RELATED APPLICATIONS

This application claims the benefit of U.S. Provisional Application No. 63/282,412, filed Nov. 23, 2021, which is incorporated herein by reference in its entirety.

### BACKGROUND

Additive manufacturing techniques, such as three-dimensional (3D) printing, are rapidly being adopted as useful techniques for a number of different applications, including rapid prototyping and fabrication of specialty components. Examples of 3D printing include powder-based printing, fused deposition modeling (FDM), and stereolithography (SLA). In SLA printing technology, a 3D structure may be built by forming one layer at a time, where a subsequent layer adheres to the previous layer.

### SUMMARY

The present disclosure provides methods and systems for three-dimensional (3D) printing. Methods and systems of the present disclosure may be used to enhance 3D printing resolution.

In an aspect, the present disclosure provides a method for processing a three-dimensional (3D) object for printing by a 3D printer at sub-pixel precision, comprising: (a) obtaining, by a computer processor, a digital model corresponding to at least a portion of the 3D object; (b) mapping, by the computer processor, the digital model on a grid of pixels, wherein an individual pixel of the grid of pixels comprises a plurality of sub-pixels, to (i) determine a set of sub-pixels of the grid of pixels that overlap with at least a portion of the digital model, and (ii) assign a containment level to a sub-pixel of the set of sub-pixels based on the overlap; and (c) modifying the containment level of at least one sub-pixel of the set of sub-pixels, to generate a containment level profile of the digital model corresponding to the grid of pixels, wherein the containment level profile is usable by the 3D printer to print the at least the portion of the 3D object.

In some embodiments of any one of the methods disclosed herein, the method further comprises, subsequent to (c), generating an average containment level of the plurality of sub-pixels of the individual pixel.

In some embodiments of any one of the methods disclosed herein, the method further comprises adjusting a light intensity level of a pixel comprising the at least one sub-pixel based on modification of the containment level of the at least one sub-pixel. In some embodiments of any one of the methods disclosed herein, the method further comprises, subsequent to (c), generating an average light intensity level of the plurality of sub-pixels of the individual pixel.

In some embodiments of any one of the methods disclosed herein, the containment level profile is indicative of a light intensity level profile corresponding to the grid of pixels, wherein the light intensity level profile is usable by a light source operatively coupled to the 3D printer to print the at least the portion of the 3D object from a mixture. In some embodiments of any one of the methods disclosed herein, the method further comprises generating an instruction for directing the light source to direct the light source to adjust a light based at least in part on the light intensity level profile. In some embodiments of any one of the methods disclosed herein, the method further comprises using the instruction to direct the light source to direct the light comprising the light intensity level profile to the mixture, to print the at least the portion of the 3D object from at least a portion of the mixture.

In some embodiments of any one of the methods disclosed herein, the at least one sub-pixel comprises one or more outermost sub-pixels of the set of sub-pixels. In some embodiments of any one of the methods disclosed herein, the one or more outermost sub-pixels comprises a plurality of outermost sub-pixels.

In some embodiments of any one of the methods disclosed herein, the at least one sub-pixel comprises a subset but not all of the set of sub-pixels.

In some embodiments of any one of the methods disclosed herein, the method further comprises selecting the at least one sub-pixel to be modified based at least in part on (i) a desired tolerance of the at least the portion of the 3D object or (ii) a design feature of the at least the portion of the 3D object.

In some embodiments of any one of the methods disclosed herein, the design feature corresponds to one or more members selected from the group consisting of (i) at least a portion of an outer surface of the 3D object, (ii) at least a portion of an inner surface of the 3D object, (iii) a distinct feature having an average dimension that is less than or equal to a threshold size, (iv) an additional distinct feature having an average dimension that is greater than the threshold size, (v) a region of the 3D object that is selected by a user of the 3D printer, and (vi) a position of a pixel comprising the at least one sub-pixel relative to an additional pixel having a containment level of greater than about 90% and an outermost pixel that overlaps with the at least the portion of the 3D object.

In some embodiments of any one of the methods disclosed herein, the design feature corresponds to two or more members selected from the group consisting of (i)-(vi).

In some embodiments of any one of the methods disclosed herein, the digital model is a digital slice of a plurality of digital slices corresponding to the 3D object, and wherein the step (c) is performed for only a subset of digital slices of the plurality of digital slices.

In some embodiments of any one of the methods disclosed herein, the modifying in (c) comprises applying a pre-defined containment level filter to the sub-pixel and one or more neighboring sub-pixels adjacent to the sub-pixel, wherein the pre-defined containment level filter defines containment levels for a plurality of sub-pixels.

In some embodiments of any one of the methods disclosed herein, the modifying comprises reducing the containment level of the at least one sub-pixel. In some embodiments of any one of the methods disclosed herein, the containment level is reduced by at least about 10%. In some embodiments of any one of the methods disclosed herein, the containment level is reduced by at least about 30%. In some embodiments of any one of the methods disclosed herein, the containment level is reduced by at least about 50%. In some embodiments of any one of the methods disclosed herein, the containment level is reduced by less than 100%.

In some embodiments of any one of the methods disclosed herein, the at least one sub-pixel comprises a first sub-pixel and a second sub-pixel, wherein (i) a degree of modification of a containment level of the first sub-pixel is substantially the same as (ii) a degree of reduction of a containment level of the second sub-pixel.

In some embodiments of any one of the methods disclosed herein, the at least one sub-pixel comprises a first sub-pixel and a second sub-pixel, wherein (i) a degree of modification of a containment level of the first sub-pixel is different than (ii) a degree of reduction of a containment level of the second sub-pixel.

In some embodiments of any one of the methods disclosed herein, the digital model comprises a two-dimensional digital model.

In some embodiments of any one of the methods disclosed herein, the digital model comprises a plane of a plurality of voxels. In some embodiments of any one of the methods disclosed herein, the individual pixel comprises m×m sub-pixels, wherein m is an integer greater than or equal to 2. In some embodiments of any one of the methods disclosed herein, the individual pixel comprises m×m sub-pixels, wherein m is an integer greater than or equal to 3.

In some embodiments of any one of the methods disclosed herein, the method further comprises storing the containment level profile in a computer memory.

In another aspect, the present disclosure provides a system for processing a three-dimensional (3D) object for printing by a 3D printer at sub-pixel precision, comprising: a computer processor in digital communication with a computer memory, wherein the computer processor is configured to: (a) obtain a digital model corresponding to at least a portion of the 3D object; (b) map the digital model on a grid of pixels, wherein an individual pixel of the grid of pixels comprises a plurality of sub-pixels, to (i) determine a set of sub-pixels of the grid of pixels that overlap with at least a portion of the digital model, and (ii) assign a containment level to a sub-pixel of the set of sub-pixels based on the overlap; and (c) modify the containment level of at least one sub-pixel of the set of sub-pixels, to generate a containment level profile of the digital model corresponding to the grid of pixels, wherein the containment level profile is usable by the 3D printer to print the at least the portion of the 3D object.

In some embodiments of any one of the systems disclosed herein, the computer processor is further configured to, subsequent to (c), generate an average containment level of the plurality of sub-pixels of the individual pixel.

In some embodiments of any one of the systems disclosed herein, the computer processor is further configured to adjust a light intensity level of a pixel comprising the at least one sub-pixel based on modification of the containment level of the at least one sub-pixel. In some embodiments of any one of the systems disclosed herein, the computer processor is further configured to, subsequent to (c), generate an average light intensity level of the plurality of sub-pixels of the individual pixel.

In some embodiments of any one of the systems disclosed herein, the containment level profile is indicative of a light intensity level profile corresponding to the grid of pixels, wherein the light intensity level profile is usable by a light source operatively coupled to the 3D printer to print the at least the portion of the 3D object from a mixture. In some embodiments of any one of the systems disclosed herein, the computer processor is further configured to generate an instruction for directing the light source to direct the light source to adjust a light based at least in part on the light intensity level profile. In some embodiments of any one of the systems disclosed herein, the computer processor is further configured to use the instruction to direct the light source to direct the light comprising the light intensity level profile to the mixture, to print the at least the portion of the 3D object from at least a portion of the mixture.

In some embodiments of any one of the systems disclosed herein, the at least one sub-pixel comprises one or more outermost sub-pixels of the set of sub-pixels. In some embodiments of any one of the systems disclosed herein, the one or more outermost sub-pixels comprises a plurality of outermost sub-pixels.

In some embodiments of any one of the systems disclosed herein, the at least one sub-pixel comprises a subset but not all of the set of sub-pixels.

In some embodiments of any one of the systems disclosed herein, the at least one sub-pixel to be modified is selected based at least in part on (i) a desired tolerance of the at least the portion of the 3D object or (ii) a design feature of the at least the portion of the 3D object.

In some embodiments of any one of the systems disclosed herein, the design feature corresponds to one or more members selected from the group consisting of (i) at least a portion of an outer surface of the 3D object, (ii) at least a portion of an inner surface of the 3D object, (iii) a distinct feature having an average dimension that is less than or equal to a threshold size, (iv) an additional distinct feature having an average dimension that is greater than the threshold size, (v) a region of the 3D object that is selected by a user of the 3D printer, and (vi) a position of a pixel comprising the at least one sub-pixel relative to an additional pixel having a containment level of greater than about 90% and an outermost pixel that overlaps with the at least the portion of the 3D object.

In some embodiments of any one of the systems disclosed herein, the design feature corresponds to two or more members selected from the group consisting of (i)-(vi).

In some embodiments of any one of the systems disclosed herein, the digital model is a digital slice of a plurality of digital slices corresponding to the 3D object, and wherein the computer processor is configured to modify the containment level for only a subset of digital slices of the plurality of digital slices.

In some embodiments of any one of the systems disclosed herein, the computer processor is configured to modify the containment level via applying a pre-defined containment level filter to the sub-pixel and one or more neighboring sub-pixels adjacent to the sub-pixel, wherein the pre-defined containment level filter defines containment levels for a plurality of sub-pixels.

In some embodiments of any one of the systems disclosed herein, the digital model is a digital slice of a plurality of digital slices corresponding to the 3D object, and the computer processor performs the step (c) for only a subset of digital slices of the plurality of digital slices.

In some embodiments of any one of the systems disclosed herein, the modifying comprises reducing the containment level of the at least one sub-pixel. In some embodiments of any one of the systems disclosed herein, the containment level is reduced by at least about 10%. In some embodiments of any one of the systems disclosed herein, the containment level is reduced by at least about 30%. In some embodiments of any one of the systems disclosed herein, the containment level is reduced by at least about 50%. In some embodiments of any one of the systems disclosed herein, the containment level is reduced by less than 100%.

In some embodiments of any one of the systems disclosed herein, the at least one sub-pixel comprises a first sub-pixel and a second sub-pixel, wherein (i) a degree of modification of a containment level of the first sub-pixel is substantially the same as (ii) a degree of reduction of a containment level of the second sub-pixel.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A schematically illustrates an example of a sampling to determine a plurality of pixels that overlap with a digital model.

FIG. 1B schematically illustrates an example of a sampling to determine a plurality of sub-pixels that overlap with a digital model.

FIGS. 2-5 illustrate examples of sub-pixel processing (e.g., blooming control) as disclosed herein.

FIG. 6 shows an example of a 3D printing system.

FIGS. 7 and 8 show additional examples of a 3D printing system.

FIG. 9 shows a computer system that is programmed or otherwise configured to implement methods provided herein.

FIG. 10 illustrates an example flowchart of a computer-implemented method for processing a 3D object for printing by a 3D printer at sub-pixel precision.

FIG. 11A illustrates an exemplary global blooming control at a level of 2-pixel blooming control.

FIG. 11B illustrates an exemplary internal blooming control at a level of 2-pixel blooming control.

FIGS. 12A-12D illustrate additional exemplary internal blooming controls.

FIG. 13 illustrates an exemplary external blooming control.

FIGS. 14A-14I illustrate exemplary eroding elements.

FIGS. 15A-15D illustrate additional exemplary eroding elements.

FIGS. 16A-16C illustrate exemplary standard internal blooming controls.

FIGS. 16D-16F illustrate exemplary internal blooming controls with disk eroding element.

FIG. 17A shows a slice of a digital model that has inner holes, e.g., hole 01, having a thin wall adjacent to the outer surface.

FIGS. 17B and 17C show an exemplary 2-pixel internal blooming control.

FIG. 17D shows an exemplary 2-pixel internal blooming control with a wall-width control.

FIG. 18A shows a slice of a digital model that has inner holes, e.g., holes 02 and 03, having a thin wall adjacent to the outer surface.

FIGS. 18B and 18C show an exemplary 3-pixel internal blooming control.

FIG. 18D shows an exemplary 3-pixel internal blooming control with a wall-width control.

FIG. 19A illustrates a top view of a 3D part.

FIG. 19B illustrates the averaged hole diameters for holes 1-8 of FIG. 19A after printing.

FIG. 19C illustrates the hole diameters for each of the holes 1-8 after printing.

FIGS. 19D-19J illustrate 7 exemplary digital models.

FIGS. 19K and 19L illustrate envelope used to surround the digital model.

FIGS. 20A and 20B show the diameter measured for the holes 1-8 and averaged hole diameters after printing with internal blooming control and envelope.

FIG. 21 shows diameter measured for the holes 1-8 under internal blooming control with disk eroding element.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “three-dimensional object” (also “3D object”), as used herein, generally refers to an object or a part that is printed by three-dimensional (“3D”) printing. The 3D object may be at least a portion of a larger 3D object or an entirety of the 3D object. The 3D object may be fabricated (e.g., printed) in accordance with a computer model of the 3D object.

The term “pixel,” as used herein, generally refers to the smallest addressable element in an image display (e.g., an optical source) that can be electrically stimulated to irradiate light. The optical source can comprise a grid or array of pixels, and the grid of pixels can be stimulated with a pattern of intensities within each pixel (e.g., based on a digital model of a 3D object that is mapped onto the grid of pixels), to project a patterned light towards a mixture as disclosed herein.

The term “sub-pixel,” as used herein, generally refers to a sub-region of the pixel. While an optical source may not be capable of selectively irradiating light at a sub-pixel resolution, a digital model can be analyzed and modified by a computer processor at a sub-pixel level. A pixel can comprise at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 25, at least about 36, at least about 49, at least about 64, at least about 81, at least about 100, or more sub-pixels. A grid of sub-pixels within a pixel can be symmetrical, e.g. m×m sub-pixels, wherein the integer m is an integer greater than or equal to 2 (e.g., 2, 3, 4, 5, 6, 7, 8, 9, 10, or more). For example, the grid of sub-pixels can be a 2×2 grid of sub-pixels, a 3×3 grid of sub-pixels, a 4×4 grid of sub-pixels, a 5×5 grid of sub-pixels, a 6×6 grid of sub-pixels, a 7×7 grid of sub-pixels, a 8×8 grid of sub-pixels, a 9×9 grid of sub-pixels, a 10×10 grid of sub-pixels, etc. Alternatively, a grid of sub-pixels within a pixel may not be symmetrical.

The term “mixture,” as used herein, generally refers to a material that is usable to print a 3D object. The mixture may be referred to as a resin. The mixture may be dispensed from a nozzle and over an area. Such area can be an area of a platform (e.g., a print window) or a film (e.g., an opaque, transparent, and/or a semi-transparent film). The mixture may be a liquid, semi-liquid, or solid. The mixture may have a viscosity sufficient to be self-supporting on the print window without flowing or sufficient flowing. The viscosity of the mixture may range, for example, from about 4,000 centipoise (cP) to about 2,000,000 cP. The mixture may be pressed (e.g., by a wiper or a build head) into a film of the mixture on or over such area (e.g., the print window, the film, etc.). A thickness of the film of the mixture may be adjustable. The mixture may include a photoactive resin. The photoactive resin may include a polymerizable and/or cross-linkable component (e.g., a precursor) and a photoinitiator that activates curing of the polymerizable and/or cross-linkable component, to thereby subject the polymerizable and/or cross-linkable component to polymerization and/or cross-linking. The photoactive resin may include a photoinhibitor that inhibits curing of the polymerizable and/or cross-linkable component. In some examples, the mixture may include a plurality of particles (e.g., polymer particles, metal particles, ceramic particles, combinations thereof, etc.). In such a case, the mixture may be a slurry or a photopolymer slurry. The mixture may be a paste. The plurality of particles may be added to the mixture. The plurality of particles may be solids or semi-solids (e.g., gels). Examples of non-metal material include metallic, intermetallic, ceramic, polymeric, or composite materials. The plurality of particles may be suspended throughout the mixture. The plurality of particles in the mixture may have a distribution that is monodisperse or polydisperse. In some examples, the mixture may contain additional optical absorbers and/or non-photoreactive components (e.g., fillers, binders, plasticizers, stabilizers such as radical inhibitors, etc.). The 3D printing may be performed with at least 1, 2, 3, 4, 5, 6, 7, 8, 9, 10 or more mixtures. A plurality of mixtures comprising different materials (e.g., different photoactive resin and/or different plurality of particles) may be used for printing a multi-material 3D object.

The terms “mixture” and “viscous liquid” may be used interchangeably in the present disclosure.

The term “particles,” as used here, generally refers to any particulate material that may be incorporated into the mixture. The particles may be incorporated to alter (e.g., increase, decrease, stabilize, etc.) a material property (e.g., viscosity) of the mixture. The particles may be configured to be melted or sintered (e.g., not completely melted). The particulate material may be in powder form. The particles may be inorganic materials. The inorganic materials may be metallic (e.g., aluminum or titanium), intermetallic (e.g., steel alloys), ceramic (e.g., metal oxides) materials, or any combination thereof. The powders may be coated by one or more polymers. The term “metal” or “metallic” generally refers to both metallic and intermetallic materials. The metallic materials may include ferromagnetic metals (e.g., iron and/or nickel). The particles may have various shapes and sizes. For example, a particle may be in the shape of a sphere, cuboid, or disc, or any partial shape or combination of shapes thereof. The particle may have a cross-section that is circular, triangular, square, rectangular, pentagonal, hexagonal, or any partial shape or combination of shapes thereof. Upon heating, the particles may sinter (or coalesce) into a solid or porous object that may be at least a portion of a larger 3D object or an entirety of the 3D object. The 3D printing may be performed with at least 1, 2, 3, 4, 5, 6, 7, 8, 9, 10 or more types of particles.

The term “a film of a mixture” or “a layer of mixture,” as used interchangeably herein, generally refers to a layer of the mixture that is usable to print a 3D object. The film of the mixture may have a uniform or non-uniform thickness across the film of the mixture. The film of the mixture may have an average thickness or a variation of the thickness that is below, within, or above a defined threshold (e.g., a value or a range). The average thickness or the variation of the thickness of the film of the mixture may be detectable and/or adjustable during the 3D printing. An average (mean) thickness of the film of the mixture may be an average of thicknesses from at least about 2, 3, 4, 5, 6, 7, 8, 9, 10, 15, 20, 30, 40, 50, 100, 200, 300, 400, 500, 1000, 2000, 3000, 4000, 5000, or more positions within the film of the mixture. An average (mean) thickness of the film of the mixture may be an average of thicknesses from at most about 5000, 4000, 3000, 2000, 1000, 500, 400, 300, 200, 100, 50, 40, 30, 20, 15, 10, 9, 8, 7, 6, 5, 4, 3, or 2 positions within the film of the mixture. A variation of the thickness of the film of the mixture may be a variance (i.e., sigma squared or “02”) or standard deviation (i.e., sigma or “o”) within a set of thicknesses from the at least about 2, 3, 4, 5, 6, 7, 8, 9, 10, 15, 20, 30, 40, 50, 100, 200, 300, 400, 500, 1000, 2000, 3000, 4000, 5000, or more positions within the film of the mixture. A variation of the thickness of the film of the mixture may be a variance or standard deviation within a set of thicknesses from the at most about 5000, 4000, 3000, 2000, 1000, 500, 400, 300, 200, 100, 50, 40, 30, 20, 15, 10, 9, 8, 7, 6, 5, 4, 3, or 2 positions within the film of the mixture.

Photopolymer-based 3D printing technology (e.g., stereolithography (SLA)) can produce a 3D structure in a layer-by-layer fashion, wherein a layer of a mixture (e.g., a photoactive resin) is exposed to a stimulus (e.g., light) to selectively cure polymeric precursors into a polymeric material within the layer of mixture to create a layer of the 3D structure. In some cases, photopolymer-based 3D printers that use bottom up illumination may project light upwards through a transparent or semi-transparent window (e.g., a window of an open platform or a vat) to cure at least a portion of the mixture disposed adjacent to the window.

For such 3D printing, a digital model corresponding to the 3D structure is sliced into a plurality of digital layers. Each digital layer of the plurality of digital layers can be used by the 3D printing system to generate a light pattern based on a grid of pixels or voxels for selectively curing at least a portion of the mixture, thereby producing a 3D structure in the layer-by-layer fashion. In some cases, printed 3D structure may have defects or inaccuracies that are smaller than the width of a pixel, e.g., due to a staircase effect (e.g., aliasing). In some cases, printed 3D structure may have defects or inaccuracies that are larger than the width of a pixel, e.g., due to light scattering off of metal particles within the mixture, projected light overspray, light scattering in boundary material, overcuring of polymeric monomers, etc. For example, the curing reaction can self-catalyze and over-cure in regions of the resin that are not directly exposed to the curing light (or photoinitiation light), but adjacent to (e.g., directly adjacent to) a border region of the curing light. As a result, the resin adjacent to the exposed edge of the slice of the 3D structure can be at least partially cured. In some cases, such inaccuracies in 3D printing due to the aforementioned overcuring of monomers and/or light scattering by particles can be referred to as blooming. In aliasing, diagonal, or curved features (e.g., lines, borders, etc.) of the digital model of the 3D printing structure is printed as group of straight lines and steps (e.g., corresponding to the resolution of the grid of pixels), thus resulting in edge-like artifacts in the printed 3D structure.

In view of the foregoing, there exists a need for alternative methods and systems (e.g., enhanced digital processing methods and systems for 3D printing) to smooth edges of the printed 3D structure, reduce the number of artifacts in the printed 3D structure, and/or enhance 3D printing resolution.

The term “blooming control” generally refers to use of any one of the methods and systems provided herein to light scattering and/or overcuring of the resin provided herein, e.g., to smooth edges of the printed 3D structure, reduce the number of artifacts in the printed 3D structure, and/or enhance 3D printing resolution.

### Methods and Systems for 3D Printing

In an aspect, the present disclosure provides a method for processing a three-dimensional (3D) object for printing by a 3D printer at sub-pixel precision. The method can comprise obtaining (e.g., by a computer processor) a digital model corresponding to at least a portion of the 3D object. The method can further comprise mapping (e.g., by the computer processor) the digital model on a grid of pixels, wherein an individual pixel (e.g., each pixel) of the grid of pixels can comprise a plurality of sub-pixels. A sub-pixel can be fully contained within the digital model, partially contained within the digital model, or outside of the digital model. The mapping can be for determining a set of sub-pixels of the grid of pixels that overlap with at least a portion of the digital model. The mapping can be for assigning a containment level to a sub-pixel of the set of sub-pixels based on the overlap. The method can further comprise modifying (e.g., by the computer processor) the containment level of at least one sub-pixel of the set of sub-pixels, to generate a containment level profile of the digital model corresponding to the grid of pixels. The containment level profile can be usable by the 3D printer to print the at least the portion of the 3D object.

In some embodiments, the individual pixel can comprise m×n sub-pixels, wherein m and n can be independently, an integer greater than or equal to 2, for example, 2, 3, 4, 5, 6, 7, 8, 9, 10, or more. In some embodiments, m and n can be the same. In some embodiments, the individual pixel can comprise m×m sub-pixels, wherein m is an integer greater than or equal to 2, for example, m can be 2, 3, 4, 5, 6, 7, 8, 9, 10, or more. In some embodiments, the individual pixel can comprise m×m sub-pixels, wherein m is an integer greater than or equal to 3, for example, m can be 3, 4, 5, 6, 7, 8, 9, 10, or more.

In some embodiments, the mapping can comprise dividing each pixel into a plurality of smaller sub-pixels while keeping the dimension of the pixel the same.

In some embodiments, the mapping can comprise super-sampling. Super-sampling can comprise scaling a digital model by a scale factor (K) in the X, Y, and Z dimensions, increasing the number of data samples that are taken at or around each pixel location corresponding to a portion of a model design, and combining the resulting values of these multiple data sampled to obtain a final value for each pixel.

A sub-pixel (e.g., each sub-pixel) can be associated with a containment level. A sub-pixel that is fully contained within the digital model can have a containment level of 100%. A sub-pixel that is outside the digital model can have a containment level of 0%. A sub-pixel that is partially contained within the digital model can have a containment level based on how much of it is contained within the model. The partial containment can be computed based on the geometry of the digital model and can be greater than 0% but less than 100%, for example, about 0.1%, about 0.5%, about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 95%, or about 99%.

The containment level of the at least one sub-pixel may be modified, while not reducing an overall containment level of a pixel comprising the at least one sub-pixel to zero. In some cases, reduction of the overall containment level of the pixel can be a combinatorial effect of reducing containment level(s) of one or more sub-pixels of the pixel. In some cases, reduction of the overall containment level of the pixel can be a combinatorial effect of (i) reducing containment level(s) of one or more first sub-pixels of the pixel and (ii) increasing containment level(s) of one or more second sub-pixels of the pixel. For example, reduction of the containment level(s) of the first sub-pixel(s) may be greater than increased containment level(s) of the second sub-pixel(s), such that in aggregate, the changes effect reduction in the overall containment level of the pixel as a whole. Alternatively, reduction of the containment level of the at least one sub-pixel may effect reduction of the containment level of the pixel as a whole to substantially zero.

As a result of modifying (e.g., reducing) containment level of one or more sub-pixels of a pixel, the overall containment level of the pixel may be modified (e.g., reduced) by at least about 1%, at least about 2%, at least about 5%, at least about 10%, at least about 15%, at least about 20%, at least about 30%, at least about 40%, at least about 50%, at least about 60%, at least about 70%, at least about 80%, at least about 85%, at least about 90%, at least about 95%, at least about 99%, or about 100%. As a result of modifying (e.g., reducing) containment level of one or more sub-pixels of a pixel, the overall containment level of the pixel may be modified (e.g., reduced) by at most about 100%, at most about 99%, at most about 95%, at most about 90%, at most about 85%, at most about 80%, at most about 70%, at most about 60%, at most about 50%, at most about 40%, at most about 30%, at most about 20%, at most about 15%, at most about 10%, at most about 5%, at most about 2%, or at most about 1%.

Modification of the containment level of the at least one sub-pixel can be the same regardless of the type or content(s) of the mixture. Alternatively, the containment level of the at least one sub-pixel can be different depending on the type or content(s) of the mixture. In some cases, when the 3D object is to be printed using a mixture comprising a plurality of particles (e.g., metal particles and/or ceramic particles), the modification of the containment level of the at least one sub-pixel can be different than that for a 3D object that is to be printed using a mixture that does not comprise the plurality of particles. In some cases, when the 3D object is to be printed using a mixture comprising a plurality of metal particles, the modification of the containment level of the at least one sub-pixel can be different than that for a 3D object that is to be printed using a mixture that comprises a plurality of ceramic particles. For example, light scattering by the metal particles and the ceramic particles can be different, and thus the modification of the containment level as disclosed herein may need to be different to compensate for the different optical properties between the metal particles and the ceramic particles.

Subsequent to modifying the containment level of the at least one sub-pixel of the set of sub-pixels, the method can further comprise generating (e.g., by the computer processor) a representative containment level of the plurality of sub-pixels of the individual pixel. The representative containment level can be an average, a median, a mean, a mode, the largest value, the smallest value, a range (e.g., a difference between the largest value and the smallest value, etc.

The containment level of the at least one sub-pixel of the set of sub-pixels can be increased, e.g., increased by at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100%, at least about 150%, at least about 200%, at least about 300%, at least about 400%, at least about 500%, or more, as compared to the containment level prior to the modification. The containment level of the at least one sub-pixel of the set of sub-pixels can be reduced, e.g., reduced by at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, or at substantially about 100%, as compared to the containment level prior to the modification. In some embodiments, the containment level can be reduced by at least about 10%. In some embodiments, the containment level can be reduced by at least about 30%. In some embodiments, the containment level can be reduced by at least about 50%. In some embodiments, the containment level can be reduced by less than 100%.

The containment level of the at least one sub-pixel of the set of sub-pixels can be increased to at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100% of a maximum containment level. The containment level of the at least one sub-pixel of the set of sub-pixels can be increased to at most about 100%, at most about 99%, at most about 95%, at most about 80%, at most about 85%, at most about 70%, at most about 60%, at most about 50%, at most about 40%, at most about 30%, at most about 20%, at most about 15%, at most about 10%, at most about 9%, at most about 8%, at most about 7%, at most about 6%, at most about 5%, at most about 4%, at most about 3%, at most about 2%, at most about 1%, at most about 0.5%, at most about 0.1%, or less of a maximum containment level.

The containment level of the at least one sub-pixel of the set of sub-pixels can be decreased to at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100% of a maximum containment level. The containment level of the at least one sub-pixel of the set of sub-pixels can be decreased to at most about 100%, at most about 99%, at most about 95%, at most about 80%, at most about 85%, at most about 70%, at most about 60%, at most about 50%, at most about 40%, at most about 30%, at most about 20%, at most about 15%, at most about 10%, at most about 9%, at most about 8%, at most about 7%, at most about 6%, at most about 5%, at most about 4%, at most about 3%, at most about 2%, at most about 1%, at most about 0.5%, at most about 0.1%, or less of a maximum containment level.

A pixel may comprise a plurality of sub-pixels comprising a first sub-pixel and a second sub-pixel. Containment levels of the first sub-pixel and the second sub-pixel can be modified by substantially the same degree (e.g., relative to each sub-pixel's respective original containment level before the modification) or can be modified to substantially the same level (e.g., whether or not the first and second sub-pixels have the same initial containment level, the two sub-pixels would be modified to the same new containment level). Alternatively or in addition to, containment levels of the first sub-pixel and the second sub-pixel can be modified by different degrees (e.g., containment level is reduced more in the first sub-pixel than that in the second sub-pixel) or can be modified to different levels (e.g., the containment degree of the first sub-pixel is modified from about 80% to about 50%, and the containment degree of the second subpixel is modified from about 80% to about 20%).

The modifying of the containment level of the at least one sub-pixel as disclosed herein can comprise adjusting a light intensity level of a pixel comprising the at least one sub-pixel. For example, subsequent to generating at least one sub-pixel having a modified containment level, a light intensity level of a pixel comprising the at least one sub-pixel having the modified containment level can be modified (e.g., as compared to the original intensity level of the pixel based on the digital model of the 3D object), e.g., to reflect modified containment level(s) of one or more sub-pixels of the pixel. A light intensity level can include a white level for 100% containment, a black level for 0% containment, and multiple grayscale levels between for partial containment within a digital model. The grayscale levels can comprise about 1%, about 2%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 99%. In some embodiments, the light intensity level of pixel comprising the at least one sub-pixel which has partial containment can be a binary profile, e.g., 0% or 100%. The light intensity level of the pixel comprising the at least one sub-pixel of the set of sub-pixels can be increased, e.g., increased by at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100%, at least about 150%, at least about 200%, at least about 300%, at least about 400%, at least about 500%, or more, as compared to the light intensity level prior to the modification. The light intensity level of the pixel comprising the at least one sub-pixel of the set of sub-pixels can be decreased, e.g., decreased by at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, or at substantially about 100%, as compared to the light intensity level prior to the modification.

The light intensity level of the pixel comprising the at least one sub-pixel of the set of sub-pixels can be increased to at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100% of a maximum light intensity level (e.g., as determined by the parameters of the optical source). The light intensity level of the pixel comprising the at least one sub-pixel of the set of sub-pixels can be increased to at most about 100%, at most about 99%, at most about 95%, at most about 80%, at most about 85%, at most about 70%, at most about 60%, at most about 50%, at most about 40%, at most about 30%, at most about 20%, at most about 15%, at most about 10%, at most about 9%, at most about 8%, at most about 7%, at most about 6%, at most about 5%, at most about 4%, at most about 3%, at most about 2%, at most about 1%, at most about 0.5%, at most about 0.1%, or less of a maximum light intensity level.

The light intensity level of the pixel comprising the at least one sub-pixel of the set of sub-pixels can be decreased to at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100% of a maximum light intensity level. The light intensity level of the pixel comprising the at least one sub-pixel of the set of sub-pixels can be decreased to at most about 100%, at most about 99%, at most about 95%, at most about 80%, at most about 85%, at most about 70%, at most about 60%, at most about 50%, at most about 40%, at most about 30%, at most about 20%, at most about 15%, at most about 10%, at most about 9%, at most about 8%, at most about 7%, at most about 6%, at most about 5%, at most about 4%, at most about 3%, at most about 2%, at most about 1%, at most about 0.5%, at most about 0.1%, or less of a maximum light intensity level.

The at least one sub-pixel comprises a first sub-pixel and a second sub-pixel. The first sub-pixel and the second sub-pixel can be part of the same pixel. Alternatively, the first sub-pixel and the second sub-pixel can be parts of different pixels. The first sub-pixel and the second sub-pixel can be adjacent (e.g., directly next to) each other. Alternatively, the first sub-pixel and the second sub-pixel may not be adjacent to each other. In some cases, (i) a degree of modification of a containment level of the first sub-pixel can be substantially the same as (ii) a degree of reduction of a containment level of the second sub-pixel. In some cases, (i) a degree of modification of a containment level of the first sub-pixel can be different than (ii) a degree of reduction of a containment level of the second sub-pixel. The degree of modification of the containment level of the first sub-pixel can be different (e.g., greater or lower) than the degree of reduction of the containment level of the second sub-pixel, by at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, at least about 100%, or more. The degree of modification of the containment level of the first sub-pixel can be different (e.g., greater or lower) than the degree of reduction of the containment level of the second sub-pixel, by at most about 100%, at most about 99%, at most about 95%, at most about 80%, at most about 85%, at most about 70%, at most about 60%, at most about 50%, at most about 40%, at most about 30%, at most about 20%, at most about 15%, at most about 10%, at most about 9%, at most about 8%, at most about 7%, at most about 6%, at most about 5%, at most about 4%, at most about 3%, at most about 2%, at most about 1%, at most about 0.5%, at most about 0.1%, or less.

Subsequent to modifying the light intensity level of the pixel of the at least one sub-pixel of the set of sub-pixels, the method can further comprise generating a representative light intensity level of the plurality of sub-pixels of the individual pixel. The representative light intensity level can be an average, a median, a mean, a mode, the largest value, the smallest value, a range (e.g., a difference between the largest value and the smallest value, etc. A plurality of pixels can be assigned with the same type of representative light intensity level. Alternatively, a plurality of pixels can be assigned with different types of representative light intensity level, e.g., depending on the shape of the digital model. For example, a first pixel corresponding to a first region of the digital model (e.g., a protruding edge of the digital model) can be assigned with an average light intensity level of the plurality of sub-pixels, while a second pixel corresponding to a second and different region of the digital model (e.g., a flat edge of the digital model) can be assigned with a median light intensity level of the plurality of sub-pixels.

The at least one sub-pixel as disclosed herein (e.g., at least one sub-pixel with modified containment level) can comprise one or more outermost sub-pixels of the set of sub-pixels. For example, a digital slice (e.g., a two-dimensional (2D) digital slice) of a 3D object can be mapped onto a grid of pixels, thus onto a grid of sub-pixels, and the containment level of one or more of the outermost sub-pixels assigned with (e.g., overlapping with) the edge or boundary of the digital slice can be modified in accordance with the methods disclosed herein. The at least one sub-pixel can comprise a plurality of outermost sub-pixels of the set of sub-pixels. The at least one sub-pixel can comprise at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 95%, at least about 99%, or more of the plurality of outermost sub-pixels of the set of sub-pixels. The at least one sub-pixel can all of the outermost sub-pixels of the set of sub-pixels.

The at least one sub-pixel as disclosed herein (e.g., at least one sub-pixel with modified containment level) can comprise a subset but not all of the set of sub-pixels. The subset of the set of sub-pixels can comprise at most about 99%, at most about 95%, at most about 90%, at most about 85%, at most about 80%, at most about 70%, at most about 60%, at most about 50%, at most about 40%, at most about 30%, at most about 20%, at most about 19%, at most about 18%, at most about 17%, at most about 16%, at most about 15%, at most about 14%, at most about 13%, at most about 12%, at most about 11%, at most about 10%, at most about 9%, at most about 8%, at most about 7%, at most about 6%, at most about 5%, at most about 4%, at most about 3%, at most about 2%, at most about 1%, or less of the set of sub-pixels.

The set of sub-pixels of the grid of pixels that overlap with the at least the portion of the digital model can comprise (e.g., can be divided into) a plurality of concentric zones (e.g., rings). For example, the set of sub-pixels can be divided into a plurality of concentric rings of pixels, wherein a concentric ring has a width of one pixel. The at least one sub-pixel as disclosed herein (e.g., at least one sub-pixel with modified containment level) can comprise the outermost concentric ring. Alternatively, the at least one sub-pixel as disclosed herein (e.g., at least one sub-pixel with modified containment level) can comprise a plurality of outermost concentric rings, e.g., at most about 2 outermost concentric rings, at most about 3 outermost concentric rings, at most about 4 outermost concentric rings, at most about 5 outermost concentric rings. at most about 6 outermost concentric rings. at most about 7 outermost concentric rings, at most about 8 outermost concentric rings, at most about 9 outermost concentric rings, or at most about 10 outermost concentric rings. The term “concentric” as used herein may not be limited to any particular shape (e.g., circular), can can be in any shape, such as, for example, circular, triangular, square, rectangular, pentagonal, hexagonal, or any partial shape or combination of shapes thereof.

The containment level profile as disclosed herein can be indicative of a light intensity level profile corresponding to the grid of pixels. The light intensity level profile can be usable by a light source operatively coupled to the 3D printer, as disclosed herein, to print the at least the portion of the 3D object from a mixture. Accordingly, the method can further comprise generating an instruction for directing the light source to direct the light source to adjust a light based at least in part on the light intensity level profile. The method can further comprise using the instruction to direct the light source to direct the light comprising the light intensity level profile to the mixture, to print the at least the portion of the 3D object from at least a portion of the mixture.

The digital model as disclosed herein can comprise a two-dimensional (2D) digital model. A 3D digital model of a 3D object can be sliced into a plurality of digital slices, and the 2D digital model can be a slice of the plurality of digital slices. The 2D digital model can comprise a plane of a plurality of pixels as disclosed herein. Alternatively, the 2D digital model can comprise a plane of a plurality of voxels. For example, the plane of voxels can be mapped onto a plane of pixels for implementing the methods as disclosed herein.

The method can further comprise storing the containment level profile as disclosed herein in a computer memory, e.g., such that the containment level profile or the relevant light intensity level profile can be used to print at least a portion of the 3D object.

Upon modification of the containment level of at least one sub-pixel of the set of sub-pixels and generation of the containment level profile, the resulting containment level profile may be different from an initial containment level profile of the digital model generated prior to the modification of the containment level.

The methods disclosed herein can yield a 3D printed object that has a higher resolution (e.g., reduced amount of defects or inaccuracies) than other methods, e.g., full pixel erosion. For example, the methods disclosed herein can be used for smoothing the surface of the printed 3D object.

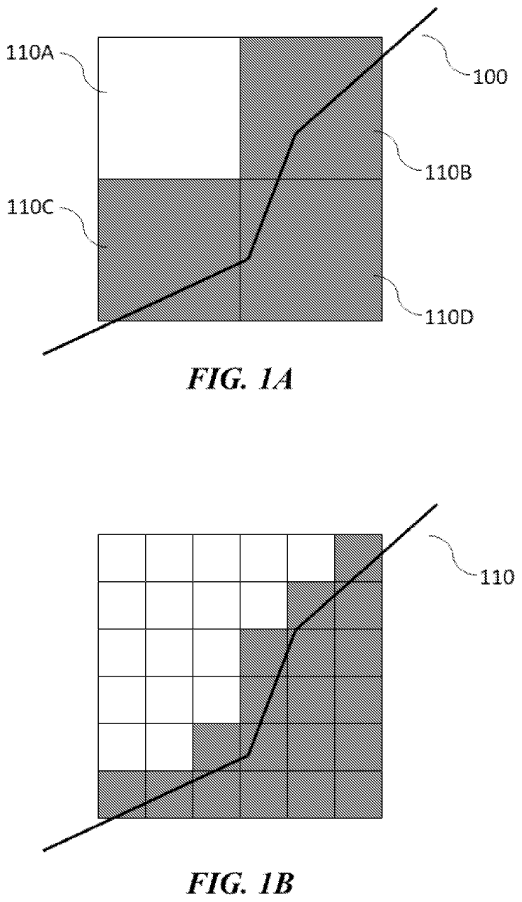

FIG. 1A illustrates an example of a sampling to determine a plurality of pixels that overlap with a digital model. An outer boundary 100 of a digital model of a 3D object (e.g., a digital 2D model of 3D object) is mapped onto a grid of pixels comprising pixels 110A, 110B, 110C, and 110D. Without sub-pixelation as disclosed herein, pixels 110B, 110C, and 110D as a whole can be identified to overlap with boundary 100 and may be assigned a 100% light intensity value for the optical source.

FIG. 1B illustrates an example of a sampling to determine a plurality of sub-pixels that overlap with a digital model. The same digital model of the 3D object as shown in FIG. 1A can be mapped onto the same grid of pixels, except that, in FIG. 1B, each pixel is divided (e.g., by the computer processor), into a plurality of sub-pixels (e.g., 3×3 sub-pixels). By using sub-pixelation, only a portion of each of the pixels 110B, 110C, and 100D can be identified to overlap with the boundary 100, and the identified subset of sub-pixels can be further processed (e.g., to further modify the containment level of one or more sub-pixels of the subset of sub-pixels) in accordance with the methods disclosed herein.

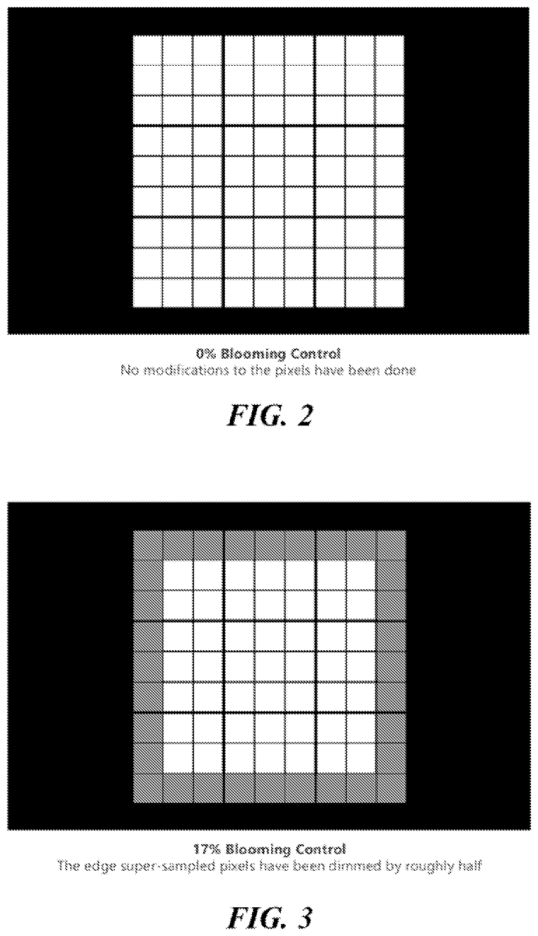

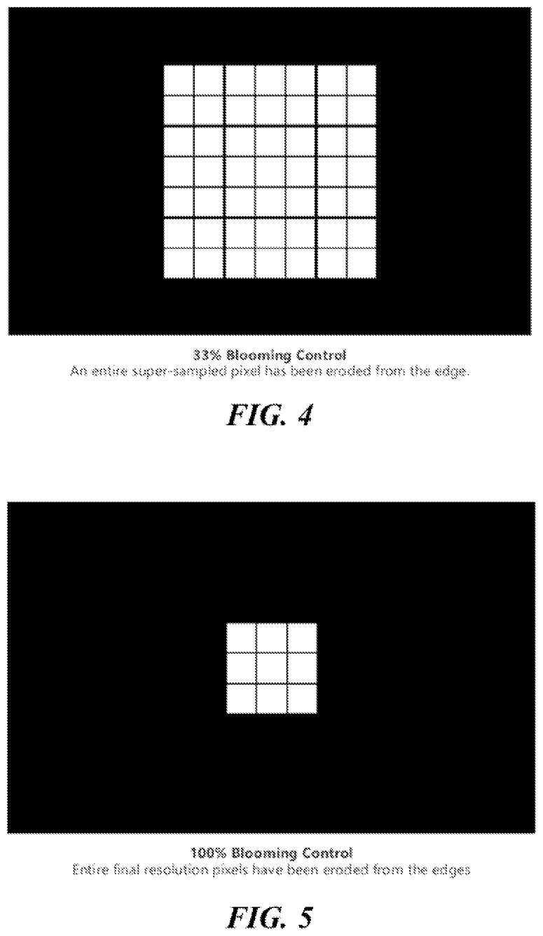

FIGS. 2-5 illustrate examples of sub-pixel processing (e.g., blooming control) as disclosed herein. A 2D digital model can be a square, which substantially overlaps with a 3×3 pixel grid. The 3D digital model substantially overlaps with all of 3×3 sub-pixels of each pixel of the 3×3 pixel grid. Thus, as shown in FIG. 2, the containment level (or light intensity level) for each pixel is 100%, as indicated by the white pixels/sub-pixels, and no grey-value pixels/sub-pixels. The methods disclosed herein can perform a combination of assigning grey values and eroding sub-pixels from the edges of the 2D digital model, to generate a containment level profile (or light intensity level profile) that is different than that shown in FIG. 2. FIG. 3 shows a containment level profile that is modified to reduce the containment level of the outermost edge of sub-pixels (or outermost concentric ring), corresponding to 17% blooming control (or 0.17-pixel blooming control), in which the containment level of the outermost edge of sub-pixels are reduced to about 50% (grayscale). FIG. 4 shows a containment level profile that is modified to reduce the containment level of the outermost edge of sub-pixels (or outermost concentric ring), corresponding to 33% blooming control (or 0.33-pixel blooming control), in which the containment level of the outermost edge of sub-pixels is reduced to 0% (black level). FIG. 5 shows a containment level profile that is modified to reduce the containment level of three outermost layers of sub-pixels (or three outermost concentric rings), corresponding to 100% blooming control (or 1-pixel blooming control), in which the containment level of three outermost layers of sub-pixels is reduced to 0% (black level).

In some embodiments, the method can further comprise selecting the at least one sub-pixel to be modified based at least in part on a desired tolerance of the at least the portion of the 3D object. For example, a 3D structure may be required to exhibit a higher tolerance (e.g., ability to tolerate deviation of the dimension from the original design) in one region of the 3D structure than that in another region of the 3D structure. In some embodiments, the method can further comprise selecting the at least one sub-pixel to be modified based at least in part on a design feature of the at least the portion of the 3D object. The selecting can be manually operated by a provider of the design of the 3D object, by an end-user of the 3D object, by operator of the 3D printing system or method disclosed herein, or automatically by the 3D printing system.

In some embodiments, the design feature can correspond to at least a portion of an outer (or interchangeably, external) surface of the 3D object.

In some embodiments, the design feature can correspond to at least a portion of an inner (or interchangeably, internal) surface or inner region of the 3D object. The 3D object can comprise an outer surface and an inner surface. The outer surface of the 3D object may be a surface (e.g., a largest continuous surface) that is in physical contact with the environment (e.g., air) surrounding the 3D object. The inner surface or inner region may not be connected to an outer surface or outer region of the 3D object, e.g., an inner void or an inner hole having an inner surface that is not connected to an outer surface of the 3D object. In some cases, the inner surface or inner region may be determined by generating a boundary of the 3D object or that of a slice of the 3D object. In some cases, the inner surface or inner region may be determined by generating a boundary of a part of the 3D object or a part of a slice of the 3D object. The boundary (e.g., which defines or encompasses the inner surface or inner region) as disclosed herein can be an artificial boundary that is not the actual outer surface boundary of the 3D object. Such boundary can be generated by various algorithms (e.g., virtual boundary), such as, for example, one or more geometric algorithms (e.g., computational geometric algorithms). Non-limiting examples of computational geometric algorithms can include, but are not limited to, Convex hull, Line segment intersection, Delaunay triangulation, Voronoi diagram, Linear programming, Closest pair of points, Farthest pair of points, Largest empty circle, Euclidean shortest path, Polygon triangulation, Mesh generation, and Boolean operations on polygons.

In some embodiments, the design feature can correspond to a distinct feature having a dimension or an average dimension (e.g., area, width, diameter, etc.) that is less than or equal to a threshold size, for example, less than or equal to 500 pixels, less than or equal to 400 pixels, less than or equal to 300 pixels, less than or equal to 200 pixels, less than or equal to 150 pixels, less than or equal to 100 pixels, less than or equal to 50 pixels, less than or equal to 45 pixels, less than or equal to 40 pixels, less than or equal to 35 pixels, less than or equal to 30 pixels, less than or equal to 25 pixels, less than or equal to 24 pixels, less than or equal to 23 pixels, less than or equal to 22 pixels, less than or equal to 21 pixels, less than or equal to 20 pixels, less than or equal to 19 pixels, less than or equal to 18 pixels, less than or equal to 17 pixels, less than or equal to 16 pixels, less than or equal to 15 pixels, less than or equal to 14 pixels, less than or equal to 13 pixels, less than or equal to 12 pixels, less than or equal to 11 pixels, less than or equal to 10 pixels, less than or equal to 9 pixels, less than or equal to 8 pixels, less than or equal to 7 pixels, less than or equal to 6 pixels, less than or equal to 5 pixels, less than or equal to 4 pixels, or less.

In some embodiments, the design feature can correspond to an additional distinct feature having a dimension or an average dimension (e.g., area, width, diameter, etc.) that is greater than a threshold size, for example, greater than 4 pixels, greater than 5 pixels, greater than 6 pixels, greater than 7 pixels, greater than 8 pixels, greater than 9 pixels greater than 10 pixels, greater than 11 pixels, greater than 12 pixels, greater than 13 pixels, greater than 14 pixels, greater than 15 pixels, greater than 16 pixels, greater than 17 pixels, greater than 18 pixels, greater than 19 pixels, greater than 20 pixels, greater than 25 pixels, greater than 30 pixels, greater than 40 pixels, greater than 50 pixels, greater than 100 pixels, greater than 150 pixels, greater than 200 pixels, greater than 300 pixels, greater than 400 pixels, greater than 500 pixels, or more.

In some embodiments, the design feature can correspond to a region of the 3D object that is selected by a user of the 3D printer. For example, the system can comprise a graphical user interface (GUI) that allows the user to select (e.g., via computationally drawing an outline) the region. Alternatively or in addition to, the system can automatically provide at least one region as at least one candidate design feature, and allow the user to select one or more of the at least one region as one or more design features to be used as provided herein.

In some embodiments, the design feature can correspond to a position of a pixel comprising the at least one sub-pixel relative to an additional pixel having a containment level of greater than a threshold containment level and an outermost pixel that overlaps with the at least the portion of the 3D object. The threshold containment level can be, for example, at least about 50%, at least about 60%, at least about 70%, at least about 80%, at least about 85%, at least about 90%, at least about 95%, at least about 99%, or about 100%. The threshold containment level can be, at most about 100%, at most about 95%, at most about 90%, at most about 85%, at most about 80%, at most about 70%, at most about 60%, at most about 50%, or less.

In some cases, the design feature can correspond to a wall width (e.g., a cross-sectional width of a high-aspect ratio feature, such as a wall, of a digital slice of the 3D object). In some embodiments, a limit of wall width, for example, 1 pixel, 2 pixel, 3 pixel, 4 pixel, 5 pixel, or more, can be specified that a blooming control will not be performed at a wall region that has a width less than or equal to 10 pixels, less than or equal to 9 pixels, less than or equal to 8 pixels, less than or equal to 7 pixels, less than or equal to 6 pixels, less than or equal to 5 pixels, less than or equal to 4 pixels, less than or equal to 3 pixels, less than or equal to 2 pixels, or less. Accordingly, such design feature can be maintained while blooming control can be performed elsewhere in the digital slice or another digital slice of the 3D object.

In some embodiments, the design feature can correspond to at least one, at least two, at least three, at least four, or more features disclosed herein.

In some embodiments, the distinct feature can comprise any shape, e.g., circle, triangle, rectangle, or star, according to the model design. In some embodiments, the distinct feature can be a hole. In some embodiments, the distinct feature can be a void.

In some embodiments, the same level of blooming control can be performed at all outer and inner surfaces (“global blooming control”). FIG. 11A illustrates an exemplary global blooming control at a level of 2-pixel blooming control. Black region (or negative region) 1101 indicates intensity level of 0%. White region (or positive region) 1102 indicates intensity level of 100%. The blooming control is performed at the gray regions, e.g., 1103 and 1108 wherein 2 pixels are eroded from the digital model. Gray region 1103 indicates a blooming control at the outer surface and gray region 1108 indicates a blooming control at the inner surface. The slice has internal holes, e.g., 1104, wherein the wall 1110 between the hole and external surface is very thin, e.g., less than 6 pixels, less than 5 pixels, less than 4 pixels, or less. The slice also has internal holes, e.g., 1105, wherein the wall 1107 between the hole and external surface is wider than 1110, e.g., at least 7 pixels, at least 8 pixels, at least 9 pixels, at least 10 pixels, or more. If 2-pixel global blooming control is performed and the wall 1110 is eroded by about 4 pixels, the wall may collapse.

In some embodiments, the blooming control can be performed only to internal surfaces (“internal blooming control”). FIG. 11B illustrates an exemplary internal blooming control at a level of 2-pixel blooming control. The blooming control is performed only to internal surfaces, e.g., 1112, between the internal hole 1111 and white region 1114. This will prevent collapse of the thin wall 1113 between the hole 1111 and external surface.

In some embodiments, the internal blooming control can be performed with an algorithm. In some embodiments, the internal blooming control algorithm can comprise: (a) inverting slice image; (b) identifying contiguous negative (or black) regions, wherein the negative regions are positive (or white) region in the original slice image; (c) selecting regions based on a threshold specified by a user; (d) applying dilation to selected regions to generate a processed image; and (e) un-inverting and subtracting the processed image from the original slice image. In some embodiments, the threshold can comprise a size of the internal negative regions, e.g., holes or voids. In some embodiments, the size can be an absolute size. In some embodiments, the size can be a relative size.

In some embodiments, the threshold can comprise a dimension or an average dimension (e.g., area, width, diameter, etc.) that is less than or equal to a size, for example, less than or equal to 500 pixels, less than or equal to 400 pixels, less than or equal to 300 pixels, less than or equal to 200 pixels, less than or equal to 150 pixels, less than or equal to 100 pixels, less than or equal to 50 pixels, less than or equal to 45 pixels, less than or equal to 40 pixels, less than or equal to 35 pixels, less than or equal to 30 pixels, less than or equal to 25 pixels, less than or equal to 24 pixels, less than or equal to 23 pixels, less than or equal to 22 pixels, less than or equal to 21 pixels, less than or equal to 20 pixels, less than or equal to 19 pixels, less than or equal to 18 pixels, less than or equal to 17 pixels, less than or equal to 16 pixels, less than or equal to 15 pixels, less than or equal to 14 pixels, less than or equal to 13 pixels, less than or equal to 12 pixels, less than or equal to 11 pixels, less than or equal to 10 pixels, less than or equal to 9 pixels, less than or equal to 8 pixels, less than or equal to 7 pixels, less than or equal to 6 pixels, less than or equal to 5 pixels, less than or equal to 4 pixels, or less. In some embodiments, the threshold can comprise a dimension or an average dimension (e.g., area, width, diameter, etc.) that is greater than a size, for example, greater than 4 pixels, greater than 5 pixels, greater than 6 pixels, greater than 7 pixels, greater than 8 pixels, greater than 9 pixels greater than 10 pixels, greater than 11 pixels, greater than 12 pixels, greater than 13 pixels, greater than 14 pixels, greater than 15 pixels, greater than 16 pixels, greater than 17 pixels, greater than 18 pixels, greater than 19 pixels, greater than 20 pixels, greater than 25 pixels, greater than 30 pixels, greater than 40 pixels, greater than 50 pixels, greater than 100 pixels, greater than 150 pixels, greater than 200 pixels, greater than 300 pixels, greater than 400 pixels, greater than 500 pixels, or more.

In some embodiments, the threshold can comprise a dimension or an average dimension (e.g., area, width, diameter, etc.) that is less than or equal to 100%, 90%, 80%, 70%, 60%, 50%, 40%, 30%, 20%, 10%, or less of a certain size, e.g., an area of the total slice region enclosed by an outer perimeter, or an area of the total white region (region with white pixels). In some embodiments, the threshold can comprise a dimension or an average dimension (e.g., area, width, diameter, etc.) that is larger than or equal to 10%, 20%, 30%, 40%, 50%, 60%, 70%, 80%, 90%, or more of a certain size, e.g., an area of the total slice region enclosed by an outer perimeter, or an area of the total white region (region with white pixels).

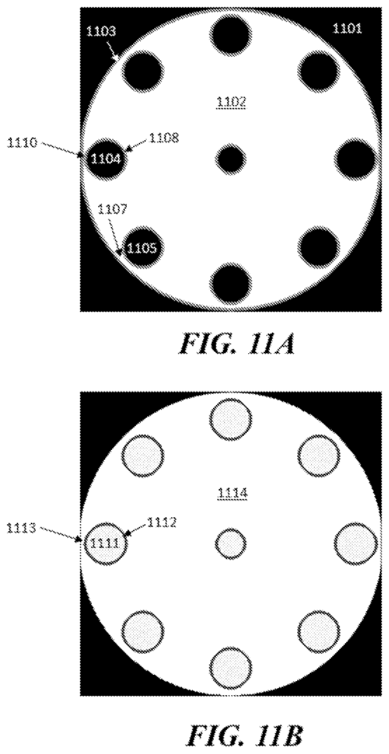

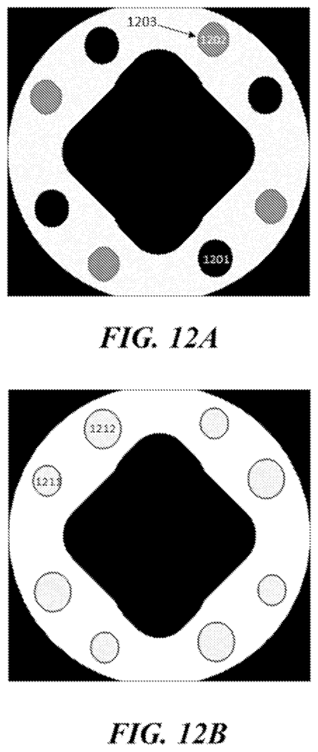

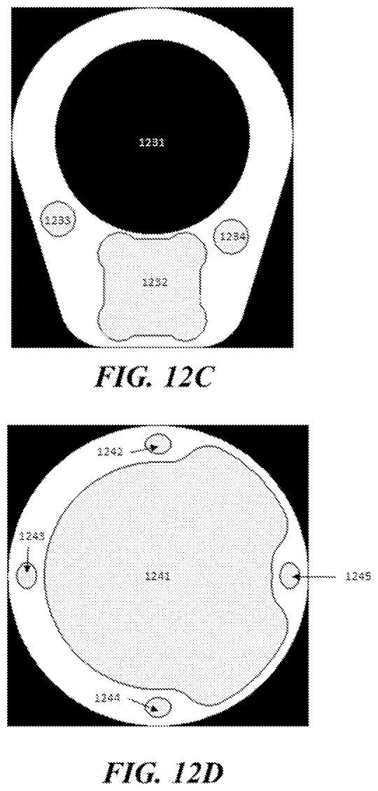

FIG. 12A illustrates an exemplary internal blooming control. The criterial/threshold in the algorithm is set to be 20 pixels, and the blooming control level is set to be 200% (2 pixel). Hole 1201 with a design size of 22 pixels is not processed for blooming control. Hole 1202 with a design size of 17 pixels is processed for blooming control and a 2-pixel blooming control is performed on hole 1202 at the interface 1203.

FIG. 12B illustrates another exemplary internal blooming control. The threshold in the algorithm is set to be less than or equal to 10% area, and the blooming control level is set to be 100% (1 pixel). Holes, e.g., 1211 and 1212, with area less than about 10% of the area of the total slice region, are processed for 100% blooming control.

FIG. 12C illustrates another exemplary internal blooming control. The threshold in the algorithm is set to be less than or equal to 40% area, and the blooming control level is set to be 67% (⅔ pixel, or 2 of 3 sub-pixels). Internal regions, e.g., 1232, 1233 and 1234, with area less than 40% of the area of the total white region, are processed for 67% blooming control. Internal region, e.g., 1231, with area larger than 40% of the area of the total white region, are not processed for blooming control.

FIG. 12D illustrates another exemplary internal blooming control. The threshold in the algorithm is set to be less than or equal to 100% of the area of the total slice region, and the blooming control level is set to be 67% (⅔ pixel, or 2 of 3 sub-pixels). All internal regions, e.g., 1241, 1242, 1243, 1244, and 1245 are processed for 67% blooming control.

In some embodiments, the blooming control can be performed only at external surfaces (“external blooming control”). This has utility for specific designs, for example, when outer diameter tolerance is critical, when inner negative regions are not critical, or when thin walls prevent global blooming control.

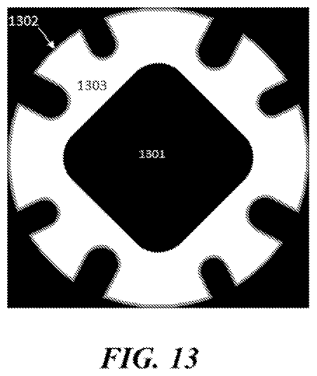

In some embodiments, the external blooming control can be performed with an algorithm. In some embodiments, the external blooming control algorithm can comprise: (a) identifying an external negative region in a slice image; (b) applying dilation to the external negative region; and (c) subtracting the dilation from the original slice image. FIG. 13 illustrates an exemplary external blooming control. External blooming control is performed to the external contour/interface 1302 of the white region 1303. No internal blooming control is performed to the internal region 1301.

In some embodiments, the digital model can be a digital slice of a plurality of digital slices corresponding to a 3D object. In some embodiment, modifying the containment level of at least one sub-pixel of the set of sub-pixels performed to a digital slice of a plurality of digital slices can be different from that performed to another digital slice of a plurality of digital slices. In some embodiment, modifying the containment level of at least one sub-pixel of the set of sub-pixels can be performed to a subset of digital slices of the plurality of digital slices. In some embodiment, modifying the containment level of at least one sub-pixel of the set of sub-pixels can be performed to at least 2 subsets, at least 3 subsets, at least 4 subsets, at least 5 subsets, at least 6 subsets, at least 7 subsets, at least 8 subsets, at least 9 subsets, at least 10 subsets, at least 15 subsets, at least 20 subsets, at least 30 subsets, at least 40 subsets, at least 50 subsets, at least 60 subsets, at least 70 subsets, at least 80 subsets, at least 90 subsets, at least 100 subsets, at least 150 subsets, at least 200 subsets, at least 250 subsets, at least 300 subsets, or more of digital slices of the plurality of digital slices.

In some embodiments, modifying the containment level of at least one sub-pixel of the set of sub-pixels can comprise applying a pre-defined containment level filter to the sub-pixel and one or more neighboring sub-pixels adjacent to the sub-pixel, wherein the pre-defined containment level filter defines containment levels for a plurality of sub-pixels.

In some embodiments, the pre-defined containment level filter defines containment levels for a plurality of pixels.

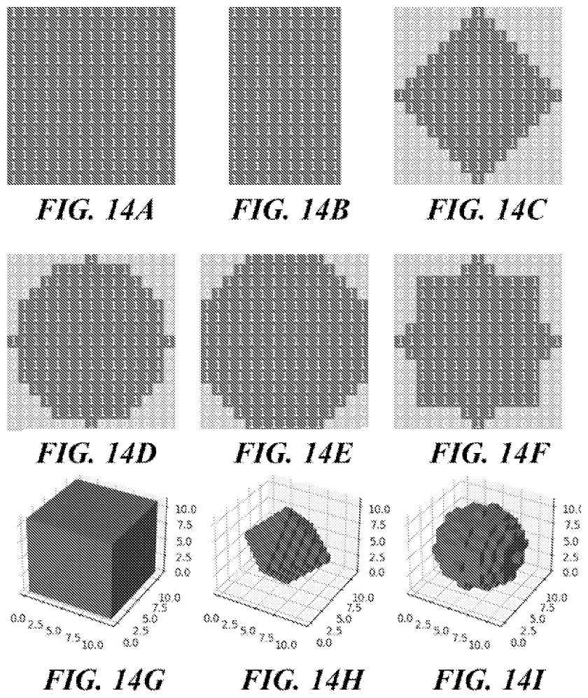

FIGS. 14A-14I illustrate exemplary eroding elements with pre-defined containment level filter that can be used in blooming control. The eroding elements can be 2 dimensional, for example square (FIG. 14A), rectangle (FIG. 14B), diamond (FIG. 14C), disk (FIG. 14D), octagon (FIG. 14E), or star (FIG. 14F). The eroding elements can be 3 dimensional, for example, cube (FIG. 14G), octahedron (FIG. 14H), or ball (FIG. 14I). At least one eroding element can be applied to one or more sub-pixel (or one or more pixels) to modify the containment level(s) of the one or more sub-pixels (or that of the one or more pixels) in accordance with a containment level pattern of the at least one eroding element. Thus, the at least one eroding element may be utilized as a filter to modify the containment level of the one or more sub-pixels (or that of the one or more pixels).

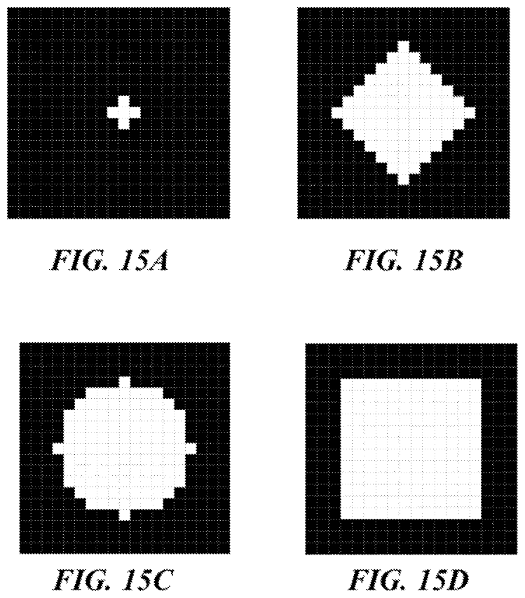

FIGS. 15A-15D illustrate additional exemplary eroding elements with pre-defined containment level filter. FIG. 15A illustrates an exemplary 1 sub-pixel disk eroding element. FIG. 15B illustrates an exemplary diamond eroding element. FIG. 15C illustrates an exemplary disk eroding element. FIG. 15D illustrates an exemplary square eroding element.

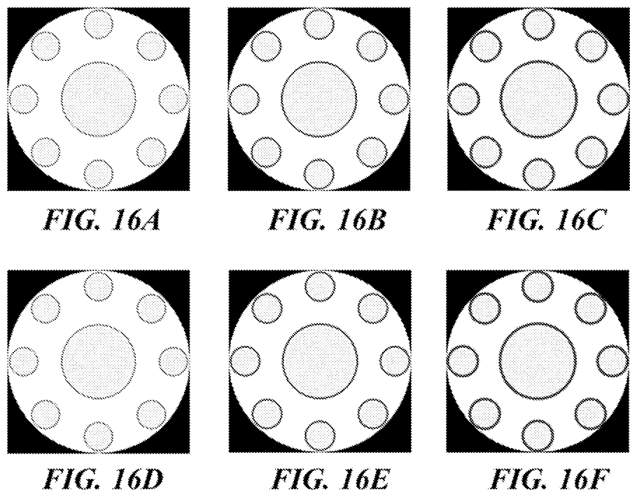

FIGS. 16A-16C show internal blooming controls at 1-pixel (FIG. 16A), 2-pixel (FIG. 16B), and 3-pixel (FIG. 16C) level. FIGS. 16D-16F show internal blooming controls with disk eroding element at 1-pixel (FIG. 16D), 2-pixel (FIG. 16E), and 3-pixel (FIG. 16F) level. Internal blooming controls with disk eroding element can have more rounded and/or circular surfaces in comparison to blooming control without such disk eroding element.

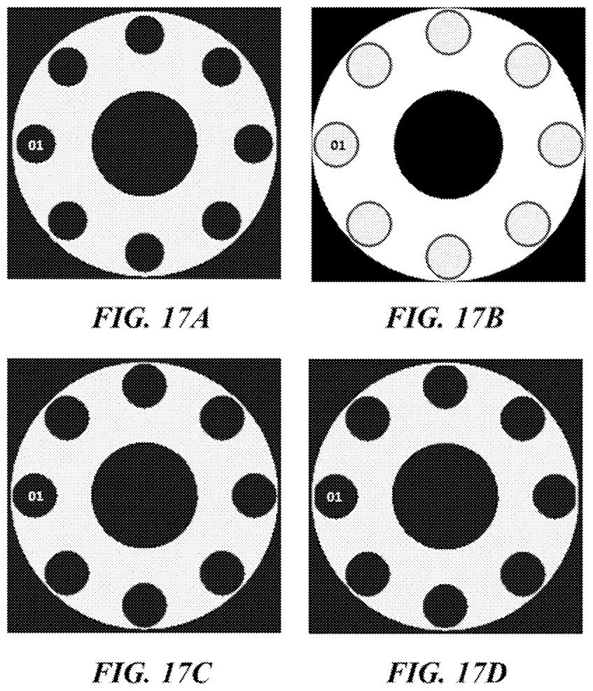

FIG. 17A shows a slice of a digital model that has inner holes, e.g., hole 01, having a thin wall adjacent to the outer surface (i.e., outermost circumference of the slice). If 2-pixel internal blooming control is performed (FIG. 17B), after the erosion of 2 pixels, the wall width is less than 1 pixel (FIG. 17C) which may not be a viable wall and may collapse. After applying a limit of 2-pixel wall-width control, any walls that are thinner than 2-pixel will not be eroded (will not reduce the containment level in the pixels contain the wall region) and thus produce a viable wall, see FIG. 17D.

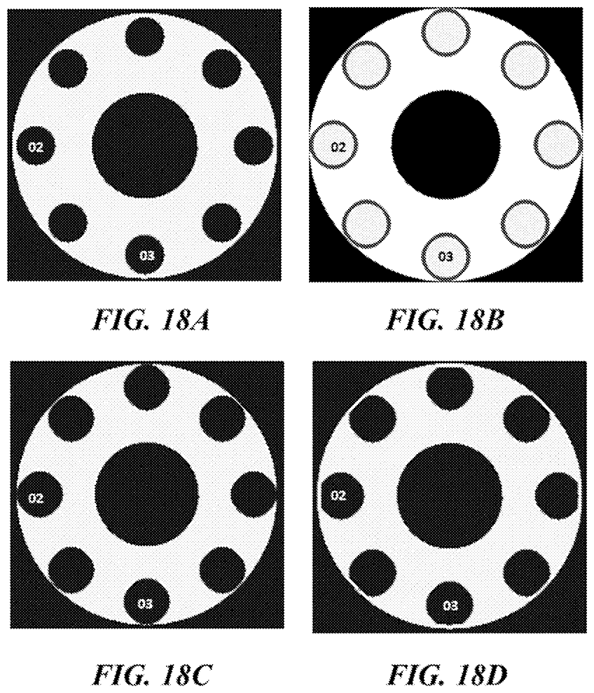

FIG. 18A shows a slice of a digital model that has inner holes, e.g., hole 02 or hole 03, having a thin wall. If 3-pixel internal blooming control is performed (FIG. 18B), after the erosion of 3 pixels, the wall is completely eroded through (FIG. 18C, hole 02) or contains unsupported pixels or sub-pixels (FIG. 18C, hole 03). After applying a limit of 2-pixel (or 3-pixel) wall-width control, any walls that are thinner than 2-pixel (or 3-pixel) will not be eroded and thus produce a viable wall, see FIG. 18D.

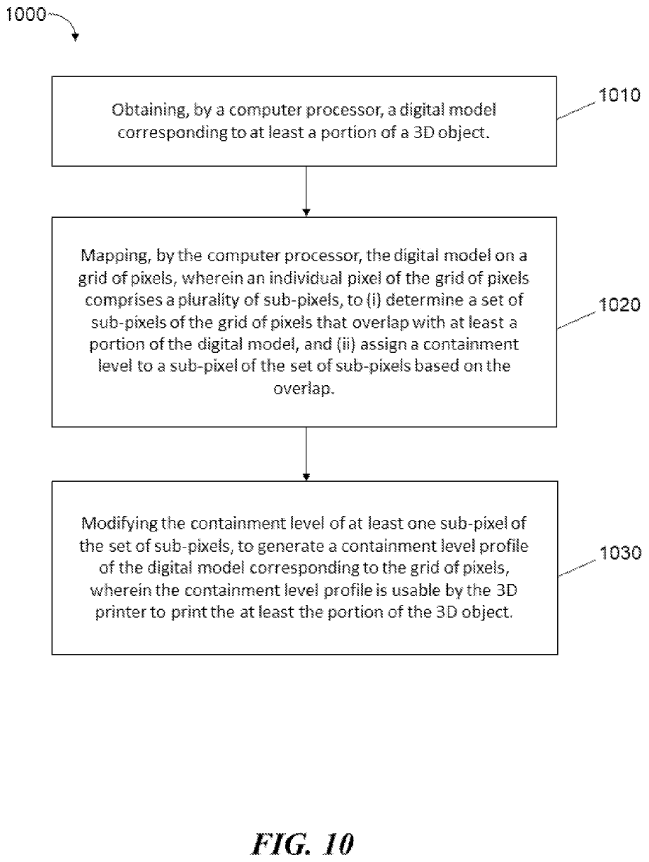

FIG. 10 illustrates an example flowchart of a computer-implemented method 1000 for processing a 3D object for printing by a 3D printer at sub-pixel precision. The method can comprise obtaining, by a computer processor, a digital model corresponding to at least a portion of a 3D object (process 1010). The method can further comprise, mapping, by the computer processor, the digital model on a grid of pixels, wherein an individual pixel of the grid of pixels comprises a plurality of sub-pixels, to (i) determine a set of sub-pixels of the grid of pixels that overlap with at least a portion of the digital model, and (ii) assign a containment level to a sub-pixel of the set of sub-pixels based on the overlap (process 1020). The method can further comprise, modifying (e.g., by the computer processor, optionally with user input) the containment level of at least one sub-pixel of the set of sub-pixels, to generate a containment level profile of the digital model corresponding to the grid of pixels, wherein the containment level profile is usable by the 3D printer to print the at least the portion of the 3D object (process 1030).

The methods and systems for blooming control, as provided herein, via modifying containment level(s) of one or more sub-pixels can be similarly performed at the sub-voxel level. In some embodiments, printing at sub-voxel precision can be performed by (a) obtaining, by a computer processor, a digital model corresponding to at least a portion of a 3D object; (b) mapping, by the computer processor, the digital model on a grid of voxels, wherein an individual voxel of the grid of voxels comprises a plurality of sub-voxels, to (i) determine a set of sub-voxels of the grid of voxels that overlap with at least a portion of the digital model, and (ii) assign a containment level to a sub-voxel of the set of sub-voxels based on the overlap; and (c) modifying the containment level of at least one sub-voxel of the set of sub-voxels, to generate a containment level profile of the digital model corresponding to the grid of pixels, wherein the containment level profile is usable by the 3D printer to print the at least the portion of the 3D object.

The systems and systems for blooming control as provided herein (e.g., via modifying containment level(s) of one or more sub-pixels or one or more sub-voxels, can be similarly performed at the pixel or voxel level, e.g., modifying (e.g., reducing) containment level(s) of one or more pixels or one or more voxels in absence of analysis and/or modification at the sub-pixel or sub-voxel level.

In some embodiments, printing at sub-pixel precision can be performed by (a) obtaining, by a computer processor, a digital model corresponding to at least a portion of a 3D object; (b) mapping, by the computer processor, the digital model on a grid of pixels, to (i) determine a set of pixels of the grid of pixels that overlap with at least a portion of the digital model, and (ii) assign a containment level to a pixels of the set of pixels based on the overlap; and (c) modifying the containment level of at least one pixel of the set of pixels, to generate a containment level profile of the digital model corresponding to the grid of pixels, wherein the containment level profile is usable by the 3D printer to print the at least the portion of the 3D object. In some cases, the at least one pixel to have the containment level modified can be determined by selecting one or more outermost pixels, a desired tolerance of the at least the portion of the 3D object, or a design feature of the at least the portion of the 3D object (e.g., (i) at least a portion of an outer surface of the 3D object, (ii) at least a portion of an inner surface of the 3D object, (iii) a distinct feature having an average dimension that is less than or equal to a threshold size, (iv) an additional distinct feature having an average dimension that is greater than a threshold size, (v) a region of the 3D object that is selected by a user of the 3D printing system, (vi) a position of a pixel (e.g., which comprises the at least one sub-pixel) relative to an additional pixel having a containment level that is greater than a threshold containment level (e.g., a containment level of greater than about 90%) and an outermost pixel that overlaps with the at least the portion of the 3D object.

In some embodiments, printing at sub-voxel precision can be performed by (a) obtaining, by a computer processor, a digital model corresponding to at least a portion of a 3D object; (b) mapping, by the computer processor, the digital model on a grid of voxels, to (i) determine a set of voxels of the grid of voxels that overlap with at least a portion of the digital model, and (ii) assign a containment level to a voxel of the set of voxels based on the overlap; and (c) modifying the containment level of at least one voxel of the set of voxels, to generate a containment level profile of the digital model corresponding to the grid of voxels, wherein the containment level profile is usable by the 3D printer to print the at least the portion of the 3D object. In some cases, the at least one voxel to have the containment level modified can be determined by selecting one or more outermost voxels, a desired tolerance of the at least the portion of the 3D object, or a design feature of the at least the portion of the 3D object (e.g., (i) at least a portion of an outer surface of the 3D object, (ii) at least a portion of an inner surface of the 3D object, (iii) a distinct feature having an average dimension that is less than or equal to a threshold size, (iv) an additional distinct feature having an average dimension that is greater than a threshold size, (v) a region of the 3D object that is selected by a user of the 3D printing system, (vi) a position of a voxel (e.g., which comprises the at least one sub-voxel) relative to an additional voxel having a containment level that is greater than a threshold containment level (e.g., a containment level of greater than about 90%) and an outermost voxel that overlaps with the at least the portion of the 3D object.

In another aspect, the present disclosure provides a system for processing a 3D object for printing by a 3D printer at sub-pixel precision. The system can comprise a computer processor in digital communication with a computer memory. The computer processor can be configured to execute or implement any one of the methods disclosed herein. The computer processor can comprise an algorithm configured to execute or implement any one or the methods disclosed herein. In some embodiments, the algorithm can comprise global blooming control algorithm. In some embodiments, the algorithm can comprise internal blooming control algorithm. In some embodiments, the algorithm can comprise external blooming control. The algorithm can allow a user to select a blooming control type (e.g., global blooming control, internal blooming control, or external blooming control) and/or variables/parameters (e.g., intensity level, blooming control level, region, limit, layer, subpixel level, etc.).

### Additional Aspects of Systems for 3D Printing

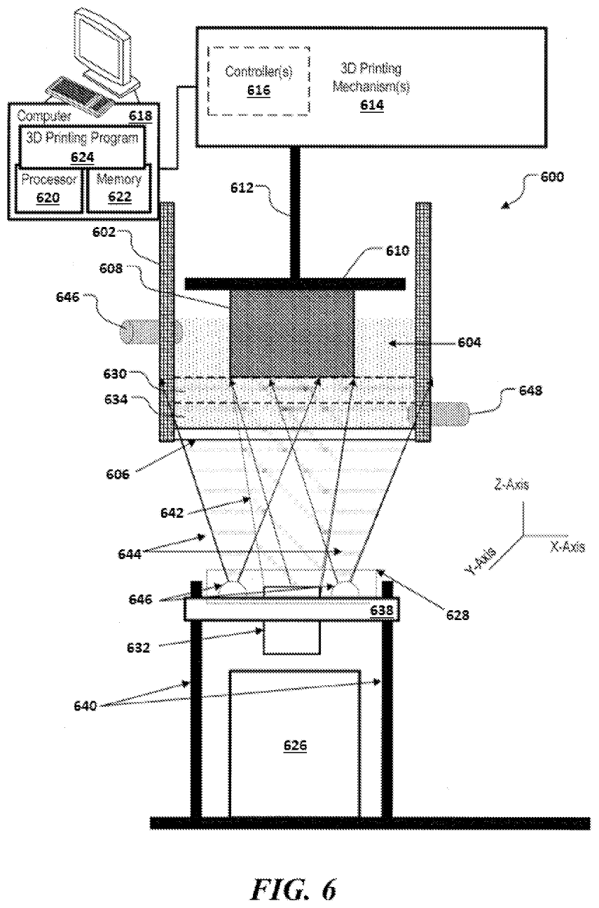

FIG. 6 shows an example of a 3D printing system 600. The system 600 includes a vat 602 to hold a mixture 604, which includes a polymeric precursor. The vat 602 includes a window 606 in its bottom through which illumination is transmitted to cure a 3D printed structure 608. The 3D printed structure 608 is shown in FIG. 6 as a block, however, in practice a wide variety of complicated shapes can be 3D printed. In some cases, the 3D printed structure 608 includes entirely solid structures, hollow core prints, lattice core prints and generative design geometries. Additionally, a 3D printed structure 608 can be partially cured such that the 3D printed structure 608 has a gel-like or viscous mixture characteristic.

The 3D printed structure 608 is 3D printed on a build head 610, which is connected by a rod 612 to one or more 3D printing mechanisms 614. The 3D printing mechanisms 614 can include various mechanical structures for moving the build head 610 within and above the vat 602. This movement is a relative movement, and thus moving pieces can be the build head 610, the vat 602, or both, in various cases. In some cases, the 3D printing mechanisms 614 include Cartesian (xyz) type 3D printer motion systems or delta type 3D printer motion systems. In some cases, the 3D printing mechanisms 614 include one or more controllers 616 which can be implemented using integrated circuit technology, such as an integrated circuit board with embedded processors and firmware. Such controllers 616 can be in communication with a computer or computer systems 618. In some cases, the 3D printing system 600 includes a computer 618 that connects to the 3D printing mechanisms 614 and operates as a controller for the 3D printing system 600.

A computer 618 can include one or more hardware (or computer) processors 620 and a memory 622. For example, a 3D printing program 624 can be stored in the memory 622 and run on the one or more processors 620 to implement the techniques described herein. The controller 618, including the one or more hardware processors 620, may be individually or collectively programmed to implement methods of the present disclosure.

Multiple devices emitting various wavelengths and/or intensities of light, including a light projection device 626 and light sources 628, can be positioned below the window 606 and in communication to the computer 618 (or other controller). In some cases, the multiple devices include the light projection device 626 and the light sources 628. The light sources 628 can include greater than or equal to about 2, 3, 4, 5, 6, 7, 8, 9, 10, or more light sources. As an alternative, the light sources 628 may include less than or equal to about 10, 9, 8 7, 6, 5, 4, 3, 2 or less light sources. As an alternative to the light sources 628, a single light source may be used. The light projection device 626 directs a first light having a first wavelength into the mixture 604 within the vat 602 through window 606. The first wavelength emitted by the light projection device 626 is selected to produce photoinitiation and is used to create the 3D printed structure 608 on the build head 610 by curing the photoactive resin in the mixture 604 within a photoinitiation layer 60630. In some cases, the light projection device 626 is utilized in combination with one or more projection optics 62632 (e.g. a projection lens for a digital light processing (DLP) device), such that the light output from the light projection device 626 passes through one or more projection optics 62632 prior to illuminating the mixture 604 within the vat 602.

In some cases, the light projection device 626 is a DLP device including a digital micro-mirror device (DMD) for producing patterned light that can selectively illuminate and cure 3D printed structures 608. The light projection device 626, in communication with the computer 618, can receive instructions from the 3D printing program 624 defining a pattern of illumination to be projected from the light projection device 626 into the photoinitiation layer 60630 to cure a layer of the photoactive resin onto the 3D printed structure 608.

In some cases, the light projection device 626 and projection optics 632 are a laser and a scanning mirror system, respectively (e.g., stereolithography apparatus). Additionally, in some cases, the light source includes a second laser and a second scanning mirror system. Such light source may emit a beam of a second light having a second wavelength. The second wavelength may be different from the first wavelength. This may permit photoinhibition to be separately controlled from photoinitiation. Additionally, in some cases, the platform 638 is separately supported on adjustable axis rails 640 from the projection optics 632 such that the platform 638 and the projection optics 632 can be moved independently.

The relative position (e.g., vertical position) of the platform 638 and the vat 602 may be adjusted. In some examples, the platform 638 is moved and the vat 602 is kept stationary. As an alternative, the platform 638 is kept stationary and the vat 602 is moved. As another alternative, both the platform 638 and the vat 602 are moved.

The light sources 628 direct a second light having a second wavelength into the mixture 604 in the vat 602. The second light may be provided as multiple beams from the light sources 628 into the build area simultaneously. As an alternative, the second light may be generated from the light sources 628 and provided as a single beam (e.g., uniform beam) into the beam area. The second wavelength emitted by the light sources 628 is selected to produce photoinhibition in the photoactive resin in the mixture 604 and is used to create a photoinhibition layer 634 within the mixture 604 directly adjacent to the window 606. The light sources 628 can produce a flood light to create the photoinhibition layer 634, the flood light being a non-patterned, high-intensity light. In some cases, the light sources 628 are light emitting diodes (LEDs) 336. The light sources 628 can be arranged on a platform 638. The platform 638 is mounted on adjustable axis rails 640. The adjustable axis rails 640 allow for movement of the platform 638 along an axis. In some cases, the platform 638 additionally acts as a heat-sink for at least the light sources 628 arranged on the platform 638.

The respective thicknesses of the photoinitiation layer 630 and the photoinhibition layer 634 can be adjusted by computer 618 (or other controller). In some cases, this change in layer thickness(es) is performed for each new 3D printed layer, depending on the desired thickness of the 3D printed layer, and/or the type of 3D printing process being performed. The thickness(es) of the photoinitiation layer 630 and the photoinhibition layer 634 can be changed, for example, by changing the intensity of the respective light emitting devices, exposure times for the respective light emitting devices, the photoactive species in the mixture 604, or a combination thereof. In some cases, by controlling relative rates of reactions between the photoactive species (e.g., by changing relative or absolute amounts of photoactive species in the mixture, or by adjusting light intensities of the first and/or second wavelength), the overall rate of polymerization can be controlled. This process can thus be used to prevent polymerization from occurring at the resin-window interface and control the rate at which polymerization takes place in the direction normal to the resin-window interface.

For example, in some cases, an intensity of the light sources 628 emitting a photoinhibiting wavelength to create a photoinhibition layer 634 is altered in order to change a thickness of the photoinhibition layer 634. Altering the intensity of the light sources 628 can include increasing the intensity or decreasing the intensity of the light sources 628. Increasing the intensity of the light sources 628 (e.g., LEDs) can be achieved by increasing a power input to the light sources 628 by controllers 616 and/or computer 618. Decreasing the intensity of the light sources 628 (e.g., LEDs) can be achieved by decreasing a power input to the light sources 628 by controllers 616 and/or computer 618. In some cases, increasing the intensity of the light sources 628, and thereby increasing the thickness of the photoinhibition layer 634, will result in a decrease in thickness of the photoinitiation layer 630. A decreased photoinitiation layer thickness can result in a thinner 3D printed layer on the 3D printed structure 608.

In some cases, the intensities of all of the light sources 628 are altered equally (e.g., decreased by a same level by reducing power input to all the light sources by an equal amount). The intensities of the light sources 628 can also be altered where each light source of a set of light sources 628 produces a different intensity. For example, for a set of four LEDs generating a photoinhibition layer 634, two of the four LEDs can be decreased in intensity by 10% (by reducing power input to the LEDs) while the other two of the four LEDs can be increased in intensity by 10% (by increasing power input to the LEDs). Setting different intensities for a set of light sources 628 can produce a gradient of thickness in a cured layer of the 3D printed structure or other desirable effects.

In some cases, the computer 618 (in combination with controllers 616) adjusts an amount of a photoinitiator species and/or a photoinhibitor species in the mixture 604. The photoinitiator and photoinhibitor species can be delivered to the vat 602 via an inlet 646 and evacuated from the vat 602 via an outlet 648. In general, one aspect of the photoinhibitor species is to prevent curing (e.g., suppress cross-linking of the polymers) of the photoactive resin in the mixture 604. In general, one aspect of the photoinitiation species is to promote curing (e.g., enhance cross-linking of the polymers) of the photoactive resin in the mixture 604. In some cases, the 3D printing system 600 includes multiple containment units to hold input/output flow from the vat 602.

In some cases, the intensities of the light sources 628 are altered based in part on an amount (e.g., volumetric or weight fraction) of the one or more photoinhibitor species in the mixture and/or an amount (e.g., volumetric or weight fraction) of the one or more photoinitiator species in the mixture. Additionally, the intensities of the light sources 628 are altered based in part on a type (e.g., a particular reactive chemistry, brand, composition) of the one or more photoinhibitor species in the mixture and/or a type (e.g., a particular reactive chemistry, brand, composition) of the one or more photoinitiator species in the mixture. For example, an intensity of the light sources 628 for a mixture 604 including a first photoinhibitor species of a high sensitivity (e.g., a high reactivity or conversion ratio to a wavelength of the light sources 628) can be reduced when compared to the intensity of the light sources 628 for a mixture 604 including a second photoinhibitor species of a low sensitivity (e.g., a low reactivity or conversion ratio to a wavelength of the light sources 628).

In some cases, the changes to layer thickness(es) is performed during the creation of the 3D printed structure 608 based on one or more details of the 3D printed structure 608 at one or more points in the 3D printing process. For example, the respective layer thickness(es) can be adjusted to improve resolution of the 3D printed structure 608 in the dimension that is the direction of the movement of the build head 610 relative to the vat 602 (e.g., z-axis) in the layers that require it.

Though the 3D printing system 600 is described in FIG. 6 as a bottom-up system where the light projection device 626 and the light sources 628 are located below the vat 602 and build head 610, other configurations can be utilized. For example, a top-down system, where the light projection device 626 and the light sources 628 are located above the vat 602 and build head 610, can also be employed.

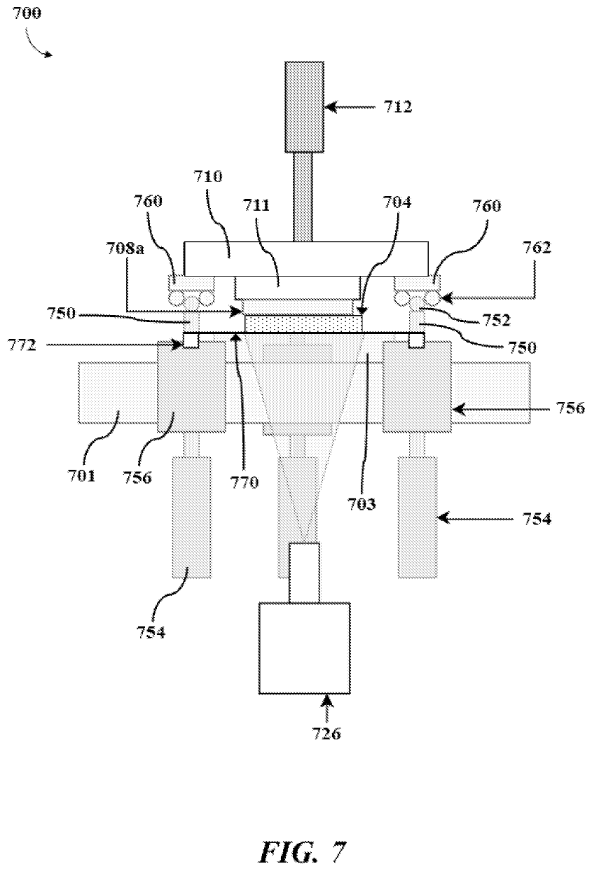

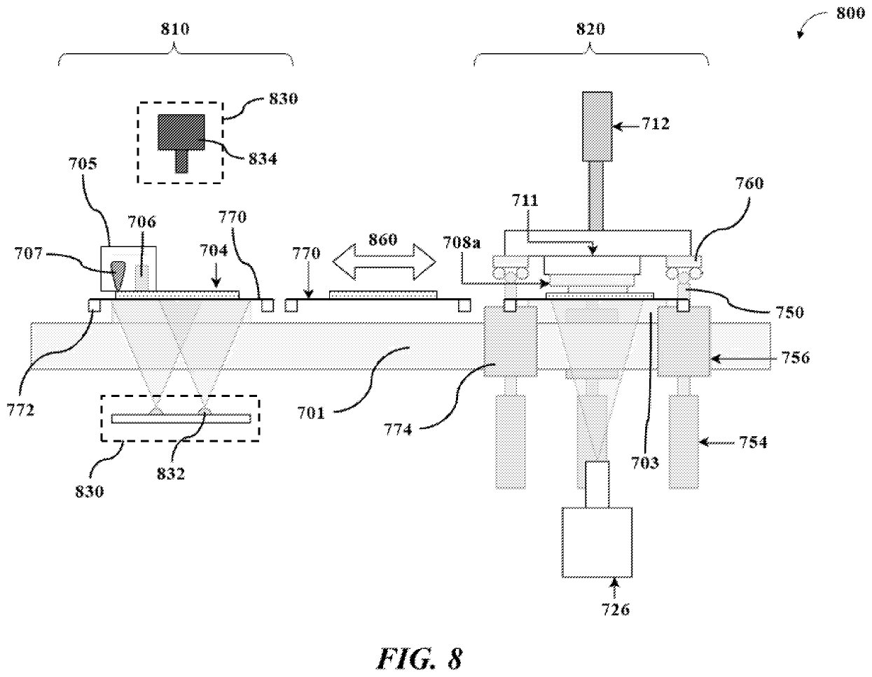

FIGS. 7 and 8 show additional examples of a 3D printing system. Referring to FIG. 7, the system 700 includes a platform 701 comprising an area (i.e., a print surface, such as a film 770) configured to hold the mixture 704 or a film of the mixture 704, which includes a photoactive resin. The mixture 704 may include a plurality of particles (e.g., metal, intermetallic, and/or ceramic particles). The platform 701 comprises a print window 703. The system 700 further comprises a film transfer unit 772 that is configured to hold the film 770. The film transfer unit is operatively coupled to one or more actuators to dispose the film 770 onto the print window 703.

The platform 701 comprises a plurality of first coupling units 750. The platform 701 is an open platform, wherein the mixture 704 is self-supporting on or adjacent to the film 770 without requiring support or being supported by any wall. The plurality of first coupling units 750 are not in contact with the mixture 704 during 3D printing. The system 700 includes a build head 710 configured to move relative to the platform 701. The build head 710 is movable by an actuator 712 (e.g., a linear actuator) operatively coupled to the build head 710. Alternatively or in addition to, the platform 701 may comprise one or more actuators to move the platform 701 relative to the build head 710. The build head 710 comprises a surface 711 configured to hold at least a portion of a 3D object 708a (e.g., a previously printed portion of the 3D object) or a different object onto which the at least the portion of the 3D object is to be printed. The surface 711 of the build head 710 may be a portion of a surface of the build head 710. Alternatively or in addition to, the surface 711 may be a surface of an object (e.g., a film or a slab) that is disposed on or adjacent to a surface of the build head 710. The build head 710 comprises a plurality of second coupling units 760. One of the plurality of second coupling units 760 of the build head 710 is configured to couple to one of the plurality of the first coupling units 750 of the platform 701 to provide an alignment of film 770 relative to the surface 711 of the build head 710 during 3D printing. In some examples, the plurality of first coupling units 750 (e.g., three first coupling units) and the plurality of second coupling units 760 (e.g., three second coupling units) may couple to generate a kinematic coupling between the build head 710 and the film 770, to provide an alignment between the build head 710 and the film 770. The relative movement between the build head and the platform may continue until each of the plurality of first coupling units 750 is coupled to its respective second coupling unit from the plurality of second coupling units 760 (or vice versa).

One or more of the plurality of first coupling units 750 of the platform 701 may comprise one or more sensors 752. Alternatively or in addition to, one or more of the plurality of second coupling units 760 of the build head 710 may comprise one or more sensors 762. The one or more sensors 752 and/or the one or more sensors 762 may be configured to at least detect coupling of the first coupling unit(s) 750 and the second coupling unit(s) 760.

The plurality of first coupling units 750 of the platform 701 may be operatively coupled to one or more actuators 754 (e.g., one or more z-axis telescopic actuators) configured to adjust a height (or protrusion) of the plurality of first coupling units 750 relative to the platform 701 (or relative to a surface of the film 770 disposed adjacent to the platform 701). The one or more actuators 754 may comprise one or more fasteners 756 (e.g., one or more shaft clamps) configured to fasten, hold on to, or stabilize a movement of the plurality of first coupling units 750 relative to the actuators 754.

The plurality of second coupling units 760 of the build head 710 may be operatively coupled to one or more actuators (e.g., one or more z-axis telescopic actuators) configured to adjust a height (or protrusion) of the plurality of second coupling units 760 relative to a surface 711 of the build head 710 (or relative to a surface of the object 708a disposed on the build head 710). The one or more actuators may comprise one or more fasteners (e.g., one or more shaft clamps) configured to fasten, hold on to, or stabilize a movement of the plurality of second coupling units 760 relative to the actuators.

One or more optical sources 726 directs one or more lights to the mixture 704 to cure the photoactive resin in the at least the portion of the mixture 704, thereby to print at least a portion of the 3D object on the surface of the build head 710 or a surface of the object 708a disposed on the surface of the build head 710. The optical source(s) 726 may direct the light(s) through the print surface 702 of the platform 701 and to the at least the portion of the mixture for 3D printing.

Referring to FIG. 8, the 3D printing system 800 comprises a mixture deposition zone 810 and a printing zone 820 that are (i) connected to a same platform 701 or (ii) coupled to the same platform 701. The system 800 further comprises a deposition head 705 configured to deposit a mixture 704 to the platform 701, print window 703, and/or film 770 configured to hold a mixture. In this example, the deposition head is configured to deposit the mixture 704 onto the film 770. The deposition head 705 comprises a nozzle 707 that is in fluid communication with a source of the mixture 704 and at least one wiper 706 configured to (i) reduce or inhibit flow the mixture 704 out of the deposition head 705, (ii) flatten the mixture 704 into a film or layer of the mixture 704, and/or (iii) remove any excess of the 704 from the film 770. The system 800 further comprises a mixture sensor 830 (e.g., a camera, a densitometer, etc.) configured to detect one or more qualities of the mixture 704 that is deposited onto the film 770. The mixture sensor comprises a mixture sensor light source 832 and a mixture sensor detector 834. The mixture sensor light source 832 is disposed beneath the film 770, and the mixture sensor detector 834 is disposed above the film 770. Alternatively or in addition to, the mixture sensor light source 832 and the mixture sensor detector 834 may be disposed inversely or on the same side of the film 770. Subsequent to depositing a layer of the mixture 704 on the film 770, the mixture sensor light source 832 may emit a sensor light (e.g., infrared light) through at least the film 770 and towards the layer of mixture 704 on or adjacent to the film 770, and the mixture sensor detector 834 may capture or detect any of the infrared light that is transmitted through the layer of the mixture 704. Measurements by the mixture sensor 830 can help determine whether a quality of the layer of the mixture 704 is sufficient to proceed with printing at least a portion of the 3D object. The printing zone 820 can comprise one or more components of the 3D printing system 700 provided in FIG. 7.

Referring to FIG. 8, the film 770 is coupled to a film transfer unit 772. The film transfer unit 772 is configured to move 860 at least between and/or over the mixture deposition zone 810 and the printing zone 820.

Other features any of the 3D printing systems and methods may be as described in, for example, U.S. Patent Publication No. 2016/0067921 (“THREE DIMENSIONAL PRINTING ADHESION REDUCTION USING PHOTOINHIBITION”), U.S. Patent Publication No. 2018/0348646 (“MULTI WAVELENGTH STEREOLITHOGRAPHY HARDWARE CONFIGURATIONS”), U.S. Patent Publication No. 2018/0333911 (“VISCOUS FILM THREE-DIMENSIONAL PRINTING SYSTEMS AND METHODS”), International Application No. PCT/US2019/068413 (“SENSORS FOR THREE-DIMENSIONAL PRINTING SYSTEMS AND METHODS”), and U.S. Provisional Application No. 62/849,596 (“STEREOLITHOGRAPHY THREE-DIMENSIONAL PRINTING SYSTEMS AND METHODS”), each of which is entirely incorporated herein by reference.

### Computer Systems

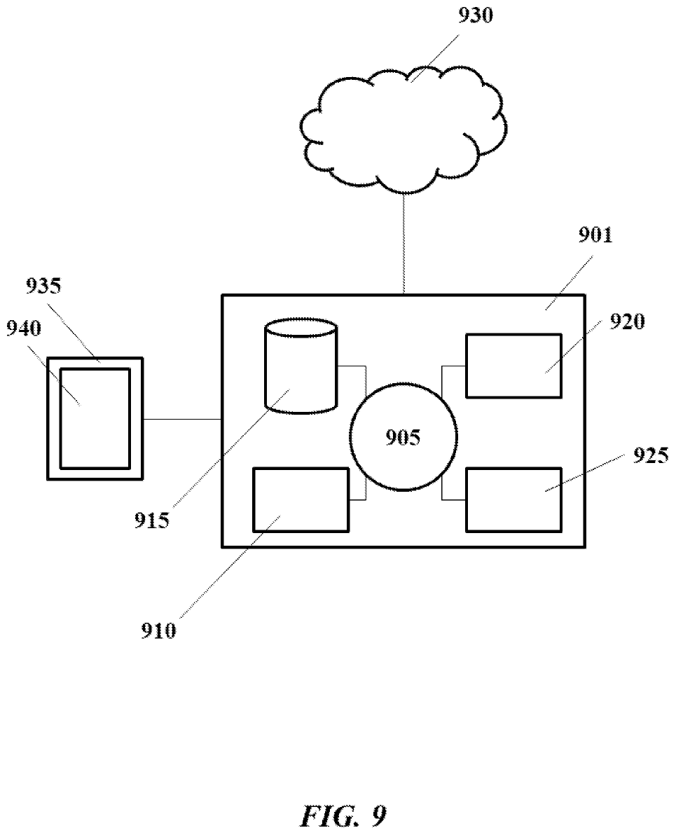

The present disclosure provides computer systems that are programmed to implement methods of the disclosure. FIG. 9 shows a computer system 901 that is programmed or otherwise configured to, for example, regulate various aspects of processing a 3D object or printing the 3D object as disclosed herein. In some cases, the computer system 901 can be an electronic device of a user or a computer system that is remotely located with respect to the electronic device. The electronic device can be a mobile electronic device.

The computer system 901 includes a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface (UI) 940 for providing, for example, (i) display the containment level profile before and/or modification thereof, (ii) display the light intensity level profile in accordance with the containment level profile, (iii) the ability for the user to adjust a degree of adjustment of the containment level or the light intensity level as disclosed herein, etc. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, determine the degree of modification of the containment level of at least one sub-pixel of the set of sub-pixels depending on the mixture type.

### EXAMPLES

### Example 1: Blooming Control Optimization

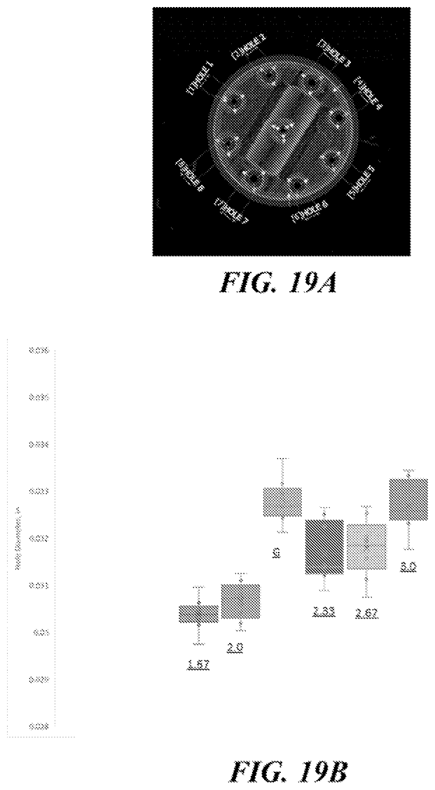

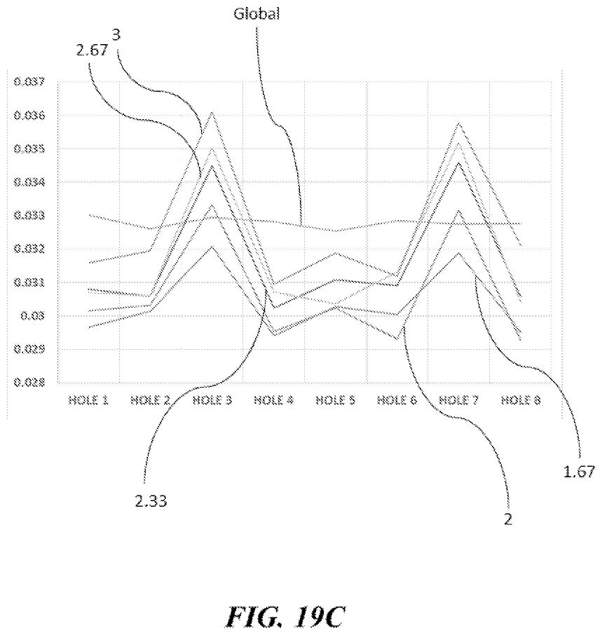

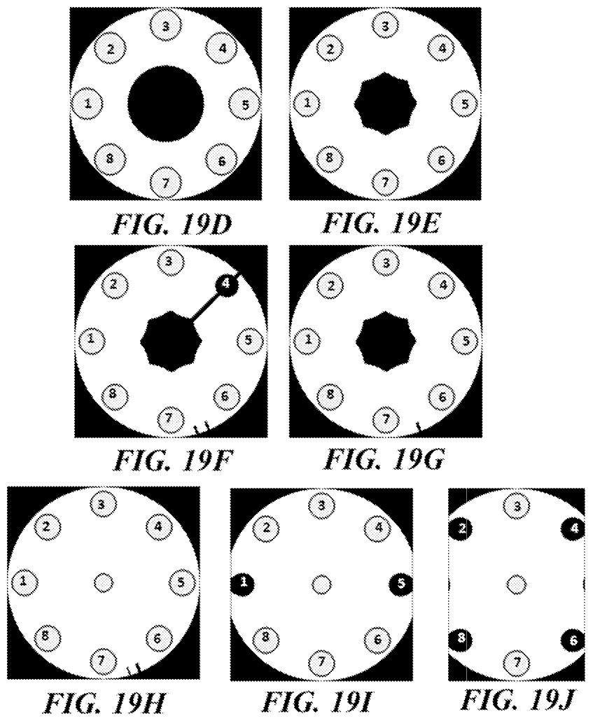

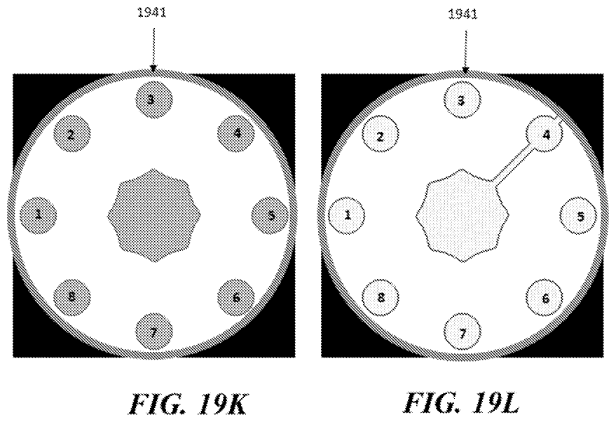

Blooming control was tested and optimized. The same 3D part (FIG. 19A) was printed with 2-pixel global blooming control (“G” and “Global”) and 5 different levels of internal blooming controls, e.g., 1.67, 2.00, 2.33, 2.67, and 3. The 3D part was transformed to 304 slices. FIGS. 19D-19J illustrate 7 exemplary digital models of slices 1 (FIG. 19D), 27 (FIG. 19E), 51 (FIG. 19F), 175 (FIG. 19G), 198 (FIG. 19H), 217 (FIG. 19I), and 228 (FIG. 19J).

With a definition of internal being completely bounded by white pixels and external being contiguous with the outside surface, only holes 3 and 7 remained internal holes during the printing process and all other holes had internal-external transitions. For example, hole 4 in FIG. 19F, holes 1 and 5 in FIG. 19I, and holes 2, 4, 6, and 8 in FIG. 19J became external.

Such internal-external transition causes discontinuous blooming control, for example, blooming control were not performed to hole 4 in FIG. 19F, holes 1 and 5 in FIG. 19I, and holes 2, 4, 6, and 8 in FIG. 19J. FIG. 19B illustrates the averaged hole diameters for holes 1-8 of FIG. 19A after printing for different blooming controls. The design value of the holes was 0.0336 in. FIG. 19C illustrates the hole diameters for each of the holes 1-8 after printing. For holes with internal-external transitions, the diameter of the holes was significantly undersized. For holes with no internal-external transitions, the blooming control was performed on all slices, and the diameter was larger than the holes with internal-external transitions. Generally, when blooming control level increased, the hole diameter also increased.

To mitigate the effect of internal-external transition, an envelope (or convex hull, 1941 in FIG. 19K and FIG. 19L) was used to surround the digital model and an internal region was defined as the region within such envelope. Therefore, all holes 1-8 became internal holes and blooming control was performed to all holes on all slices.

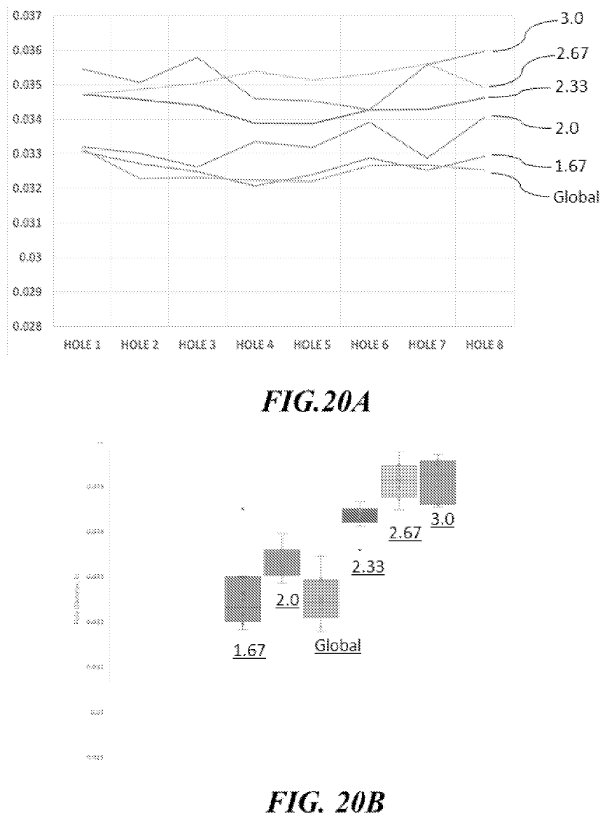

FIGS. 20A and 20B show the diameter measured for the holes 1-8 and averaged hole diameters after printing. The hole diameters were more consistent and a blooming control at a level of 2-pixel produced holes with diameter close to the design value.

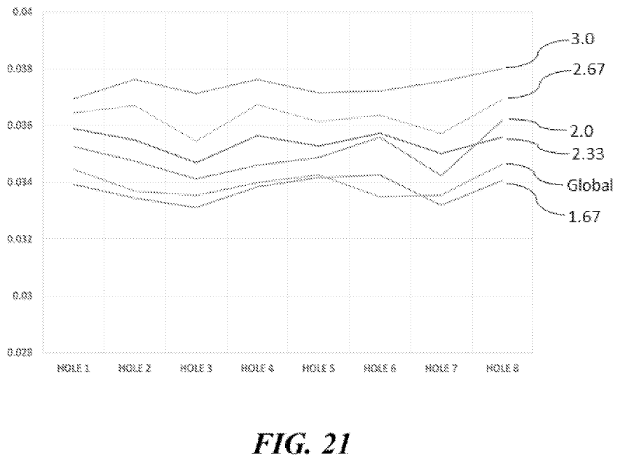

Blooming control with disk eroding element can further help increase sub-pixel resolution. FIG. 21 shows under internal blooming control with disk eroding element, the diameters of the holes were consistent.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-27. (canceled)

28. A system for processing a three-dimensional (3D) object for printing by a 3D printer at sub-pixel precision, comprising:
a computer processor in digital communication with a computer memory, wherein said computer processor is configured to:
(a) obtain a digital model corresponding to at least a portion of said 3D object;
(b) map said digital model on a grid of pixels, wherein an individual pixel of said grid of pixels comprises a plurality of sub-pixels, to (i) determine a set of sub-pixels of said grid of pixels that overlap with at least a portion of said digital model, and (ii) assign a containment level to a sub-pixel of said set of sub-pixels based on said overlap; and
(c) modify said containment level of at least one sub-pixel of said set of sub-pixels, to generate a containment level profile of said digital model corresponding to said grid of pixels, wherein said containment level profile is usable by said 3D printer to print said at least said portion of said 3D object.

29. The system of claim 28, wherein said computer processor is further configured to, subsequent to (c), generate an average containment level of said plurality of sub-pixels of said individual pixel.

30. The system of claim 28, wherein said computer processor is further configured to adjust a light intensity level of a pixel comprising said at least one sub-pixel based on modification of said containment level of said at least one sub-pixel.

31. The system of claim 30, wherein said computer processor is further configured to, subsequent to (c), generate an average light intensity level of said plurality of sub-pixels of said individual pixel.

32. The system of claim 28, wherein said containment level profile is indicative of a light intensity level profile corresponding to said grid of pixels, wherein said light intensity level profile is usable by a light source operatively coupled to said 3D printer to print said at least said portion of said 3D object from a mixture.

33. The system of claim 32, wherein said computer processor is further configured to generate an instruction for directing said light source to direct said light source to adjust a light based at least in part on said light intensity level profile.

34. The system of claim 33, wherein said computer processor is further configured to use said instruction to direct said light source to direct said light comprising said light intensity level profile to said mixture, to print said at least said portion of said 3D object from at least a portion of said mixture.

35. The system of claim 28, wherein said at least one sub-pixel comprises one or more outermost sub-pixels of said set of sub-pixels.

36. The system of claim 35, wherein said one or more outermost sub-pixels comprises a plurality of outermost sub-pixels.

37. The system of claim 28, wherein said at least one sub-pixel comprises a subset but not all of said set of sub-pixels.

38. The system of claim 28, wherein at least one sub-pixel to be modified is selected based at least in part on (i) a desired tolerance of said at least said portion of said 3D object or (ii) a design feature of said at least said portion of said 3D object.

39. The system of claim 38, wherein said design feature corresponds to one or more members selected from the group consisting of (i) at least a portion of an outer surface of said 3D object, (ii) at least a portion of an inner surface of said 3D object, (iii) a distinct feature having an average dimension that is less than or equal to a threshold size, (iv) an additional distinct feature having an average dimension that is greater than said threshold size, (v) a region of said 3D object that is selected by a user of said 3D printer, and (vi) a position of a pixel comprising said at least one sub-pixel relative to an additional pixel having a containment level of greater than about 90% and an outermost pixel that overlaps with said at least said portion of said 3D object.

40. The system of claim 39, wherein said design feature corresponds to two or more members selected from the group consisting of (i)-(vi).

41. The system of claim 28, wherein said digital model is a digital slice of a plurality of digital slices corresponding to said 3D object, and wherein said computer processor is configured to modify said containment level for only a subset of digital slices of said plurality of digital slices.

42. The system of claim 1, wherein said computer processor is configured to modify said containment level via applying a pre-defined containment level filter to said sub-pixel and one or more neighboring sub-pixels adjacent to said sub-pixel, wherein the pre-defined containment level filter defines containment levels for a plurality of sub-pixels.

43. The system of claim 28, wherein said digital model is a digital slice of a plurality of digital slices corresponding to said 3D object, and wherein computer processor performs the step (c) for only a subset of digital slices of said plurality of digital slices.

44. The system of claim 28, wherein said modifying comprises reducing said containment level of said at least one sub-pixel.

45. The system of claim 44, wherein said containment level is reduced by at least about 10%.

46. (canceled)

47. (canceled)

48. The system of claim 44, wherein said containment level is reduced by less than 100%.

49. The system of claim 28, wherein said at least one sub-pixel comprises a first sub-pixel and a second sub-pixel, wherein (i) a degree of modification of a containment level of said first sub-pixel is substantially the same as (ii) a degree of reduction of a containment level of said second sub-pixel.
